(19) United States
(12) Patent Application Publication
(10) Pub. No.: US 2024/0342769 A1
(43) Pub. Date: Oct. 17, 2024

(54) Automated Cleaning Systems For Seed Treaters And Related Methods

(71) Applicant: MONSANTO TECHNOLOGY LLC, Saint Louis, MO (US)

(72) Inventors: Bryan HARTNEY, Saint Louis, MO (US); Greg Allen REINECCIUS, Chanhassen, MN (US); Kwan Y. THAI, O'Fallon, MO (US)

(21) Appl. No.: 18/634,842

(22) Filed: Apr. 12, 2024

Related U.S. Application Data
(60) Provisional application No. 63/459,452, filed on Apr. 14, 2023.

(51) Int. Cl. B08B 9/08

(52) U.S. Cl. CPC B08B 9/0813; B08B 2209/08; B08B 2215/00

(57) ABSTRACT

Seed treatment cleaning systems and methods are provided. One example system includes a delivery assembly configured to couple to the seed treater, and a supply assembly configured to couple to the delivery assembly. The delivery assembly includes a cover plate, and a sprayer and a recovery wand coupled to the cover plate. The supply assembly includes a tank configured to hold cleaning fluid, a pump in communication with the tank and sprayer, and a vacuum in communication with the recovery wand. The pump is configured to pump the cleaning fluid from the tank to the sprayer for cleaning a mixing chamber of the seed treater of residual seed treatment and/or seeds. The vacuum source is configured to create a vacuum at the recovery wand for retrieving the cleaning fluid from the seed treater's mixing chamber, and the recovery wand is configured to provide the retrieved cleaning fluid to the tank.

### CROSS-REFERENCE TO RELATED APPLICATION

This application claims the benefit of, and priority to, U.S. Provisional Application No. 63/459,452, filed on Apr. 14, 2023. The entire disclosure of the above-referenced application is incorporated herein by reference.

### FIELD

The present disclosure generally relates to automated cleaning systems for seed treatment devices (e.g., seed treaters such as batch seed treaters, continuous flow seed treaters, etc. for use in applying one or more treatment formulations to seeds; etc.) and to related methods of cleaning seed treatment devices, for example, using the cleaning systems.

### BACKGROUND

This section provides background information related to the present disclosure which is not necessarily prior art.

Seeds are often coated or treated with one or more active ingredients, such as biological or chemical agents, using a seed treatment device to enhance the seeds (e.g., improve viability, improve longevity, provide protection, etc.). Devices used to coat the seeds (e.g., corn, soybean, cotton, wheat, etc.) may be designed for continuous or batch operation. Typically, a seed treating device includes a mixing chamber for receiving seeds (e.g., a defined amount of seeds or a continuous flow of seeds, etc.) and a treatment formulation to be applied to the seeds, and baffles secured within the mixing chamber to facilitate mixing of the seeds and the treatment formulations. When the treating process for the seeds is complete, the treated seeds are discharged, and additional seeds are provided into the treating device to begin another treating process. The treating device is manually cleaned by a user (or a person) as needed.

### SUMMARY

This section provides a general summary of the disclosure and is not a comprehensive disclosure of its full scope or all of its features.

Example embodiments of the present disclosure generally relate to cleaning systems for use in cleaning seed and/or seed treatment formulation residue in a seed treatment device. In some example embodiments, such a cleaning system generally includes a fluid delivery assembly generally coupled to (e.g., releasably, etc.) and in fluid communication with the seed treatment device for cleaning seed and/or seed treatment formulation residue in the seed treatment device, and a fluid supply assembly (e.g., a mobile fluid supply assembly, etc.) generally coupled to and in fluid communication with the fluid delivery assembly.

In one example embodiment, such a cleaning system generally includes a fluid delivery assembly and a fluid supply assembly. The fluid delivery assembly generally includes a cover plate configured to detachably couple to a lid of a seed treatment device, a sprayer extendable into a mixing chamber of the seed treatment device, and a recovery wand extendable into the mixing chamber of the seed treatment device. The fluid supply assembly generally includes a tank in fluid communication with the recovery wand, a pump in fluid communication with the tank and the sprayer, and a vacuum source. The pump is configured to pump cleaning fluid from the tank to the mixing chamber of the seed treatment device via the sprayer for cleaning the mixing chamber of the seed treatment device of residual seed treatment and seeds. The recovery wand is configured to retrieve cleaning fluid from the mixing chamber of the seed treatment device via a vacuum created by the vacuum source and provide the retrieved cleaning fluid to the tank.

In another example embodiment, such a cleaning system generally includes a fluid delivery assembly and a fluid supply assembly. The fluid delivery assembly generally includes a cover plate configured to detachably couple to a lid of a seed treatment device, a sprayer having a spray arm extendable into a mixing chamber of the seed treatment device and at least one spray nozzle attached to the spray arm. The spray arm is configured to linearly descend along its longitudinal axis a defined distance relative to the cover plate and linearly retract along its longitudinal axis.

In another example embodiment, such a cleaning system generally includes a fluid delivery assembly and a fluid supply assembly. The fluid delivery assembly includes a sprayer and a recovery wand configured to extend into and out of a mixing chamber of a seed treater (e.g., a continuous flow seed treater, etc.). The fluid supply assembly is configured to couple to the fluid delivery assembly, and includes a pump and a vacuum source. The pump is configured to pump cleaning fluid to the sprayer for use in cleaning the mixing chamber of the seed treater of residual seed treatment and/or seeds. And, the vacuum source is configured to create a vacuum at the recovery wand for use in retrieving the cleaning fluid from out of the mixing chamber of the seed treater.

In another example embodiment, a method of cleaning a mixing chamber of a seed treater is provided, wherein the seed treater is configured to mix seeds and a seed treatment in the mixing chamber. The method generally includes pumping cleaning fluid from a tank to a sprayer located in the mixing chamber of the seed treater; discharging the cleaning fluid from the sprayer into the mixing chamber of the seed treater for cleaning the mixing chamber of residual seed treatment and/or seeds; retrieving, via a recovery wand located in the mixing chamber of the seed treater, the cleaning fluid from the mixing chamber; and transporting the retrieved cleaning fluid from the recovery wand to the tank.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 is a perspective view of an example embodiment of a seed treatment cleaning system of the present disclosure, for use in cleaning seed residue and/or seed treatment formulation residue in a seed treatment device;

FIG. 2 is a partial fragmentary perspective view of the seed treatment cleaning system and the seed treatment device of FIG. 1;

FIG. 3 is a top perspective view of a lid of the seed treatment device of FIG. 1;

FIG. 4 is a bottom perspective view of the lid of FIG. 3;

FIG. 5 is a side view of a recovery assembly of the seed treatment cleaning system of FIG. 1, for use in retrieving fluid (e.g., water, etc.) from the seed treatment device;

FIG. 6 is a perspective view of a sprayer assembly of the seed treatment cleaning system of FIG. 1, for use in delivering fluid (e.g., water, etc.) to the seed treatment device;

FIG. 7 is a perspective front view of a fluid supply assembly of the seed treatment cleaning system of FIG. 1, for use in supplying fluid (e.g., water, etc.) to the seed treatment device;

FIG. 8 is a front view of the fluid supply assembly of FIG. 7;

FIG. 9 is a side view of the fluid supply assembly of FIG. 7;

FIG. 10 is a perspective view of a pump assembly of the seed treatment cleaning system of FIG. 1, for use in delivering fluid to the seed treatment device;

FIG. 11 is a partial fragmentary perspective view of the treatment cleaning system and the seed treatment device of FIG. 1;

FIG. 12 is a perspective view of a door assembly of the present disclosure, for use in a seed treatment device such as the seed treatment device of FIG. 1;

FIG. 13 is a partial fragmentary perspective view of the door assembly of FIG. 12;

FIG. 14 is a perspective view of a sprayer assembly of the present disclosure, for use in delivering fluid (e.g., water, etc.) to a seed treatment device such as the seed treatment device of FIG. 1;

FIG. 15 is a perspective view of a tank assembly of the present disclosure, for use in a seed treatment cleaning system such as the seed treatment cleaning system of FIG. 1;

FIG. 16 is an enlarged perspective view of a filter in the tank assembly of FIG. 15;

FIG. 17 is a perspective view of a reservoir of the present disclosure, for use in storing spent fluid (e.g., spent water, etc.);

FIG. 18 is a perspective view of another reservoir of the present disclosure, for use in storing spent fluid;

FIG. 19 is a perspective view of an example embodiment of a seed treatment cleaning system of the present disclosure, for use in cleaning seed residue and/or seed treatment formulation residue in a seed treatment device;

FIG. 20 is a side view of the seed treatment cleaning system and the seed treatment device of FIG. 19;

FIG. 21 is a partial fragmentary perspective view of the seed treatment cleaning system and the seed treatment device of FIG. 19; and

FIG. 22 is a perspective view of another example embodiment of a seed treatment cleaning system of the present disclosure, for use in cleaning seed residue and/or seed treatment formulation residue in a seed treatment device.

Corresponding reference numerals indicate corresponding parts throughout the several views of the drawings.

### DETAILED DESCRIPTION

Seed treatment devices are used to mix seeds with a combination of active ingredients, for example, treatment formulations, thereby coating and treating the seeds with the active ingredients (or treatment formulations). The seeds received in and/or provided to the seed treatment devices may include, for example, a defined amount of seeds or a continuous flow of seeds (e.g., a batch of seeds, etc.). When the treating process for the seeds is complete, the treated seeds are discharged, and additional seeds (and treatment formulation) may be provided into the treating device to begin another treating process. In this regard, the treating device may be considered a continuous treater. Over time, some portions of the seeds and/or treatment formulation may not discharge from the treating device. In turn, this may cause build-up and/or accumulation of seeds and/or treatment formulation inside the treating device. This build-up of seeds and/or treatment formulation may be cleaned hourly, daily, weekly, a number of times per day, a number of times per week, after a defined number of treatments, etc. depending on, for example, the treatment products being applied, end product quality, treater operations, etc. For example, the build-up may be cleaned once per week for some corn seeds, twice a week for some soybean seeds, etc. Currently, a user (a person) is required to manually clean the build-up of seeds and/or treatment formulation by soaking and/or scraping the build-up while having a full protective suit on to protect against chemical exposure. This is a tedious and uncomfortable process for the user as the temperature inside the protective suit may reach high levels since the average ambient temperature around the treating device may be more than 80 degrees Fahrenheit.

Uniquely, the cleaning devices, systems and methods herein provide for an automated cleaning process through the use of various components such as pumps, vacuum sources, sprayers, recovery wands, etc. For example, the cleaning devices, systems and methods herein utilize retractable sprayers and controllable pumps to, for example, automatically spray pressurized fluid (e.g., water, cleaning solutions, etc.) in a mixing chamber of a seed treatment device (or a seed treater, or a treating device, etc.) thereby cleaning the seed treatment device, and controllable vacuum sources and recovery wands to retrieve the fluid from the mixing chamber. As such, cleaning of the seed treatment device may be automated (e.g., fully automated, etc.) and may occur during off-hours of a site (e.g., during the night, at breaks, etc.), thereby eliminating the need of a user (in a protective suit) to clean the device and improving efficiency as a user is not required to be present.

Further, the cleaning devices and systems herein leverage components that may be used with existing seed treatment devices (e.g., existing/current continuous treaters, etc.) implemented at sites. As such, the cleaning devices, and systems herein and/or existing seed treatment devices may be retrofit through minimal modifications such that the cleaning devices and systems may be used with existing seed treatment devices.

Example embodiments will now be described more fully with reference to the accompanying drawings. The description and specific examples included herein are intended for purposes of illustration only and are not intended to limit the scope of the present disclosure.

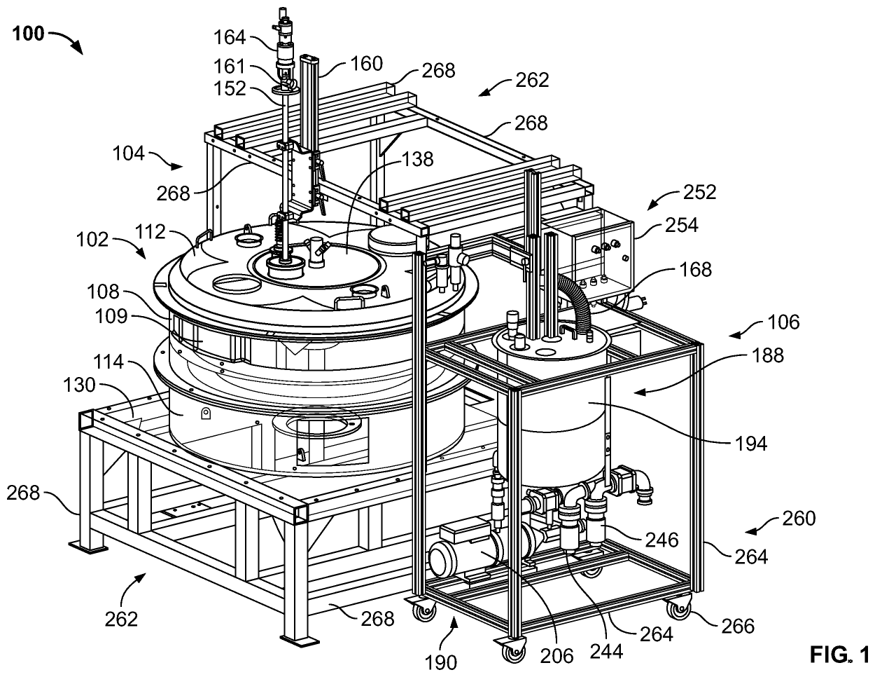

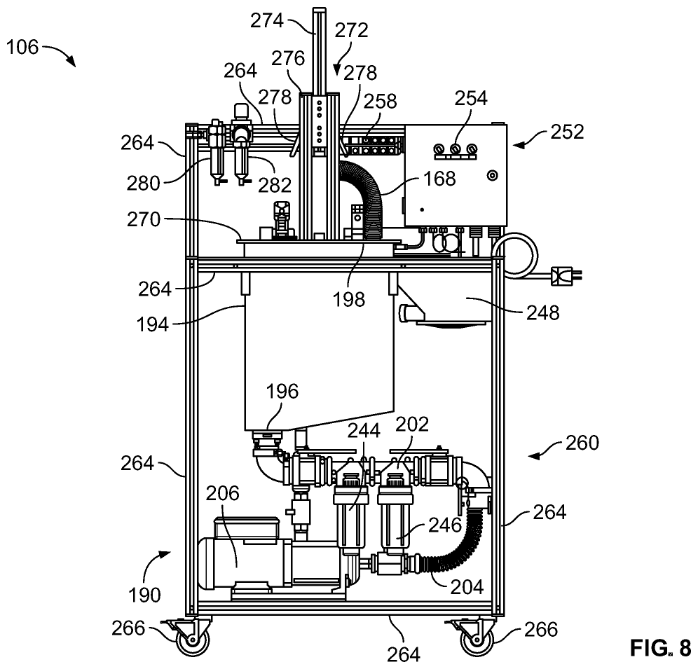

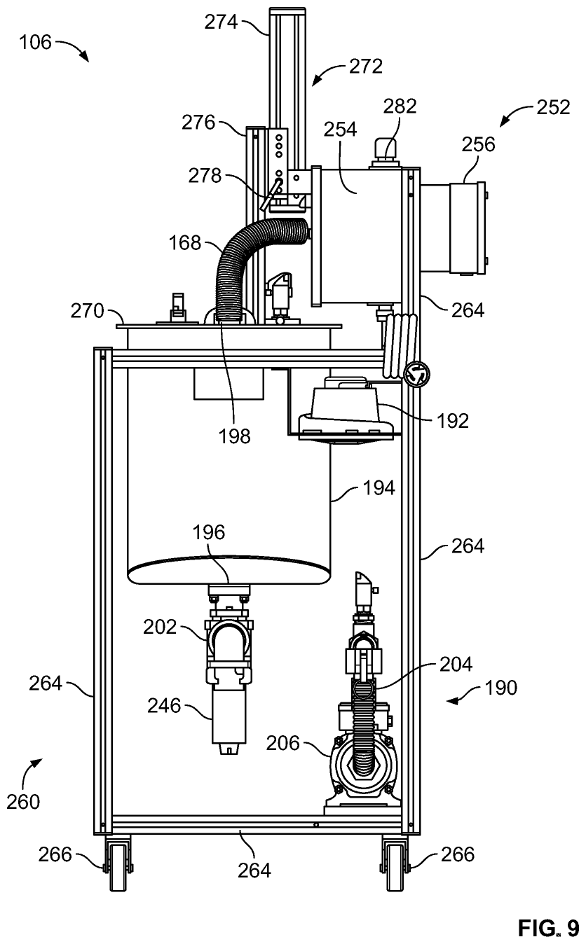

FIGS. 1-11 illustrate an example embodiment of a seed treatment system 100 including one or more aspects of the present disclosure, for use in treating seeds, applying treatment formulations to seeds, and/or cleaning seed and/or treatment formulation build-up. The seed treatment system 100 may be employable as part of a desired seed treatment system such as a continuous seed treatment system, etc.

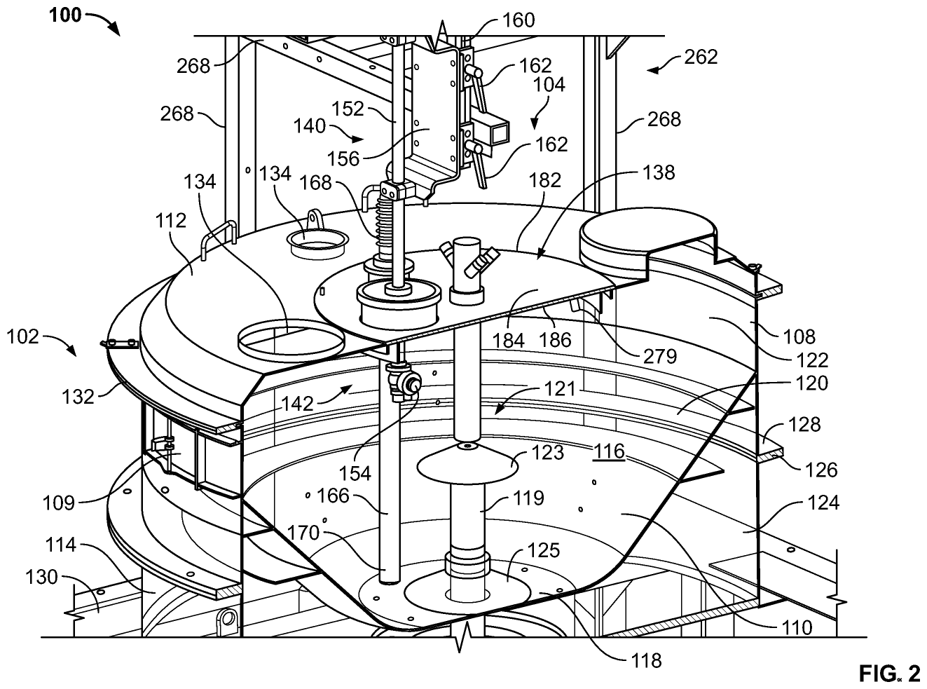

As shown in FIGS. 1-2, the illustrated seed treatment system 100 generally includes a seed treatment device (or a seed treater) 102, a fluid delivery assembly 104, and a fluid supply assembly 106. As further explained herein, the fluid delivery assembly 104 is generally coupled (e.g., detachably coupled, etc.) to and in fluid communication with the seed treatment device 102, and the fluid supply assembly 106 is generally coupled (e.g., detachably coupled, etc.) to and in fluid communication with the fluid delivery assembly 104 (e.g., via suitable tubing, piping, etc.). Through this configuration, and as further explained below, the seed treatment device 102 may be substantially cleaned of possible seed and/or seed treatment formulation residue remaining after one or more seed treatments in the device 102, by the fluid supply assembly 106 pumping fluid (e.g., water, cleaning solution, etc.) to the fluid delivery assembly 104, and the fluid delivery assembly 104 spraying the fluid (e.g., pressured water, cleaning solution, etc.) into the seed treatment device 102. With this in mind, the fluid delivery assembly 104 and the fluid supply assembly 106 may collectively be referred to as (or be parts of) a cleaning system for the seed treatment device 102.

The cleaning fluid described herein may include water, such as heated water (e.g., whereby the system may be operable for pumping water, spraying water, retrieving water, etc.). It should be appreciated that any other suitable cleaning fluids may be employed such as, for example, flocculant agents, surfactants, etc. (e.g., whereby the system may be operable for pumping other cleaning fluids, spraying other cleaning fluids, retrieving other cleaning fluids, etc.).

The seed treatment device 102 may be any one of the various example devices found in, for example, Applicant's U.S. Provisional Application No. 63/405,754 and PCT Publication No. WO 2021/067433, the entire disclosures of which are incorporated herein by reference, or another suitable treater device. For example, the seed treatment device 102 of FIGS. 1-2 generally includes a stationary portion such as a body (or a stator) 108, a rotating portion such as a rotor 110 positioned in (or at least partly in) the body 108, a lid 112 configured to detachably (or removably) couple to the body 108, and a housing 114. As show in FIG. 2, the body 108, the rotor 110, and the lid 112 generally define at least a portion of a mixing chamber 116 in which seeds, and a seed treatment formulation, are mixed. The mixing chamber 116 includes a vertical axis and an open interior portion in which seeds, and a seed treatment formulation, are mixed.

In the illustrated embodiment, the rotor 110 is positioned generally within the body 108 such as, for example, in a lower portion of the body 108. The rotor 110 includes an inner surface that is generally concave or bowl-shaped with a generally circular, planar base (or bottom) 118 and an annular or cone-shaped side wall 120. The cone-shaped side wall 120 of the rotor 110 extends from the base 118 towards an annular wall 122 of the body 108. In such examples, the angular side wall 120 of the rotor 110 is in a close-fitting relationship with the annular wall 122 of the body 108 such that seeds and/or treatment formulation cannot pass between the rotor 110 and the body 108. Although the body 108 and the rotor 110 are described as having annular shaped walls, it should be appreciated that the body 108 and rotor 110 may have other shapes and configurations than described herein that are within the scope of the present disclosure.

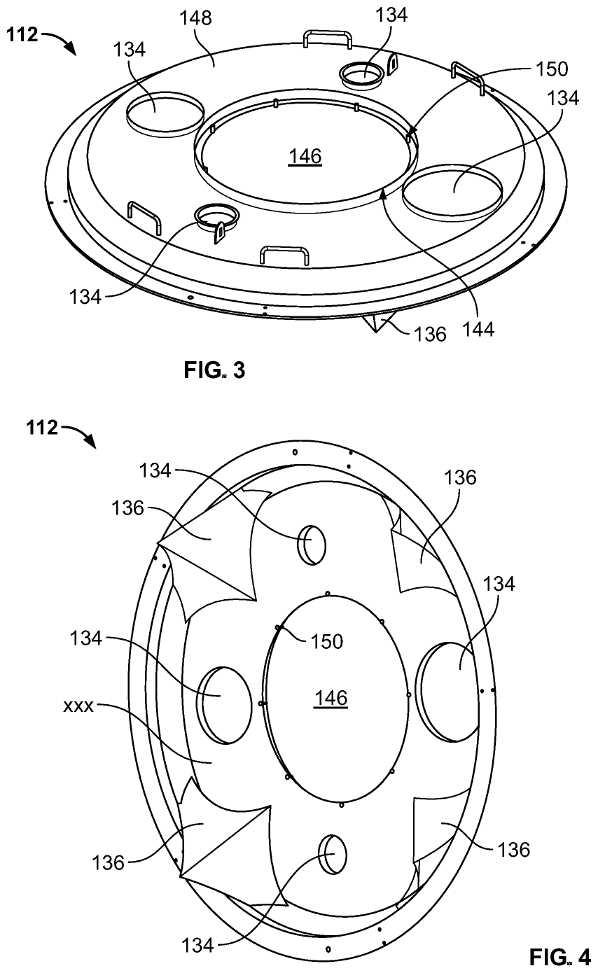

The rotor 110 is configured to rotate relative to the body 108 and about the vertical axis of the mixing chamber 116. In various embodiments, the rotor 110 may be configured to rotate in one direction or two directions (e.g., bidirectionally rotation, etc.) around a shaft 119 extending through the base 118 of the rotor 110 and through a flange 125. For example, a driver may be coupled to the rotor 110 via the shaft 119 and configured to drive 360-degree rotation of shaft 119 and by extension the rotor 110 about the vertical axis (e.g., a rotational axis, etc.) relative to the body 108 and the lid 112. The driver may include a motor, such as an electric motor, configured to cause the rotor 110 to rotate and a controller configured to control rotation (e.g., speed, direction, etc.) of the rotor 110. Such rotation of the rotor 110 (in either direction) may cause guides or protruding members (not visible) extending from the base 118 and/or wall 120 of the rotor to direct seeds and a seed treatment formulation in the lower portion of the mixing chamber 116 to flow upwards along the inner surface of the rotor 110 (e.g., along the wall 120, etc.) and along the inner surface of the body 108 (e.g., along the wall 122, etc.) toward the lid 112, where the seeds and the seed treatment formulation engage baffles 136 (see, e.g., FIGS. 3-4) on or near the lid 112 and are redirected by the baffles 136 generally inwardly and downwardly with respect to the mixing chamber 116. As a result, the seeds, and the seed treatment formulation mix, thereby coating the seeds with the seed treatment formulation.

The body 108 of the seed treatment device 102 defines an exit opening in an upper portion thereof. The exit opening is configured to allow the seeds to exit, discharge from, etc. the mixing chamber 116 after the treatment formulation has been applied to the seeds (e.g., the exit opening is, broadly, in fluid communication with the mixing chamber 116, etc.) regardless of the direction of rotation of the rotor 110. In such examples, the exit opening may be in communication with a seed collector for receiving the seeds exiting the mixing chamber 116.

The body 108 includes a door 109 configured to cover the exit opening and open to accommodate the seeds exiting, discharging from, etc. the mixing chamber 116. In such examples, the door 109 may be inlayed within the body 108 and have a curvature corresponding to a curvature of the annular wall 122 of the body 108. The door 109 may be pivotable (e.g., slidable, etc.) along the annular wall 122 of the body 108 to open and/or cover the exit opening. In some embodiments, the door 109 may be configured to close the exit opening while the seeds and treatment formulation are being mixed together in the mixing chamber 116. The door 109 may be selectively operable, such as by a controller, etc.

In various embodiments, the door 109 may include a sealing member positioned adjacent to one or more edges of the door 109. This sealing member may prevent (and sometimes eliminate) water, seeds, seed treatment formulation, etc. from escaping from the mixing chamber 116 when the door 109 is in its closed position covering the exit opening.

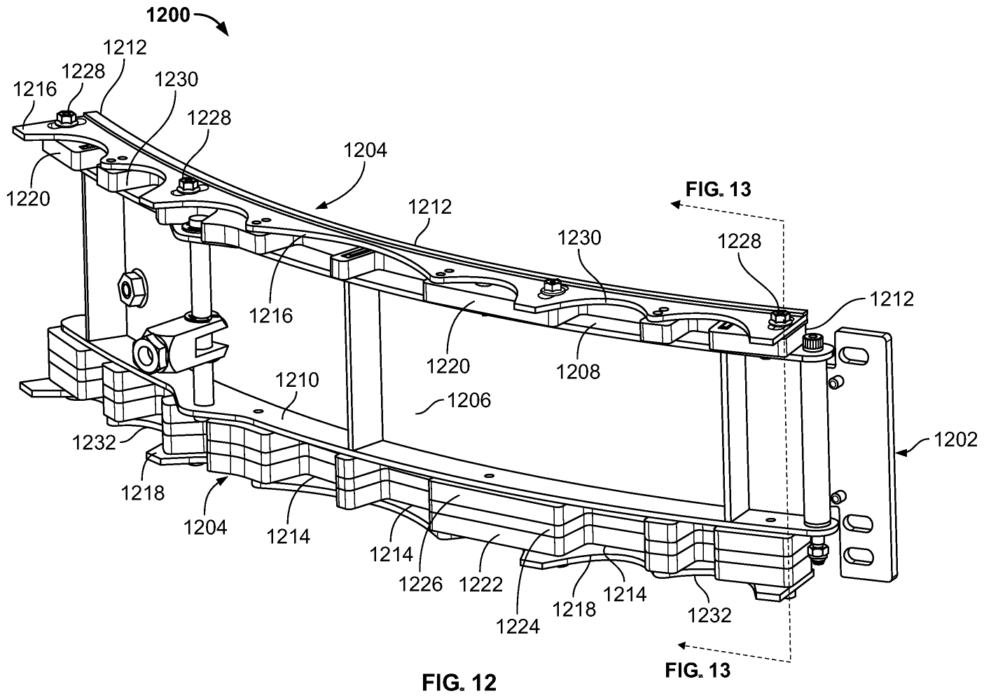

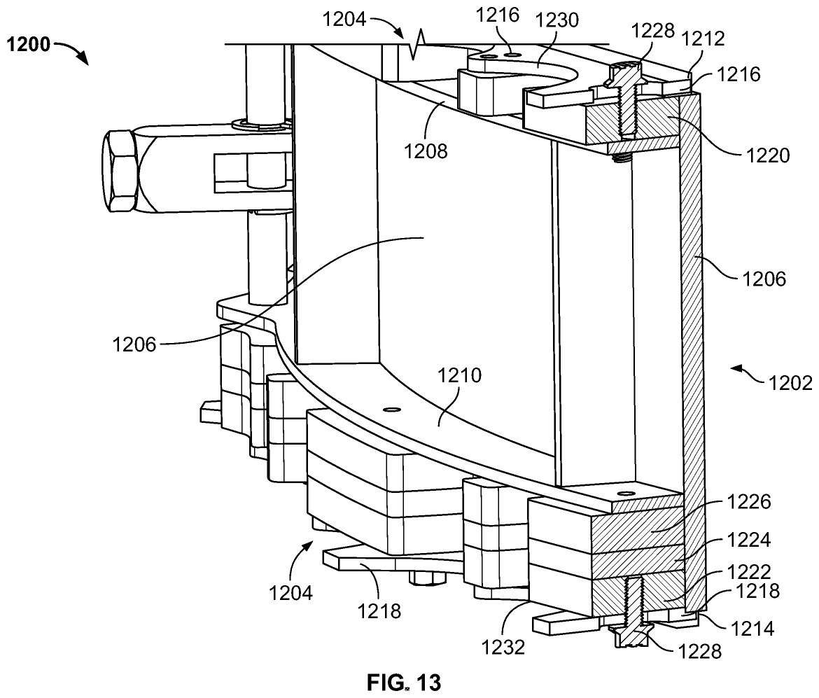

For example, FIGS. 12-13 illustrate an example door assembly 1200 for use in a seed treatment device such as the seed treatment device 102 of FIGS. 1-2. As shown, the door assembly 1200 generally includes a door 1202 and a door seal assembly 1204. The door 1202 may be substantially similar to the door 109 of FIGS. 1-2 and function in a similar manner. For example, the door 1202 may be pivotable (e.g., slidable, etc.) along the annular wall 122 of the body 108 when the door assembly 1200 is coupled to the seed treatment device 102 of FIGS. 1-2. As shown, the door 1202 generally includes a base member 1206, and ledge members 1208, 1210 extending from opposing sides (e.g., top and bottom sides) of the base member 1206.

The door seal assembly 1204 generally includes an upper seal 1212, a lower seal 1214, an upper seal bracket 1216, and a lower seal bracket 1218. In the illustrated embodiment of FIGS. 12-13, the upper and lower seals 1212, 1214 are “U” seals wrapped around a portion of the upper and lower seal brackets 1216, 1218, respectively. For instance, the seals 1212, 1214 each include two leg portions extending on top and bottom surfaces of the brackets 1216, 1218, and a middle portion extending between the leg portions and on a side surface of the brackets 1216, 1218. Although the seals 1212, 1214 are shown and described as “U” seals positioned around top and bottom portions of the door seal assembly 1204, it should be appreciated that other seals having different shapes, configurations, etc. may be employed if desired. For example, in some embodiments, the door seal assembly 1204 may include one or more seals positioned along sides of the door 1202, the entire perimeter of the door 1202, etc.

The seals 1212, 1214 are formed of compressible material such as rubber, silicone, and/or another suitable material. This allows portions of the seals 1212, 1214 to compress against the door 1202 (e.g., upper and lower edge portions of the base member 1206, etc.), the annular wall 122 of body 108 when the door assembly 1200 is coupled to the seed treatment device 102 of FIGS. 1-2., and the brackets 1216, 1218. With this arrangement, the seals 1212, 1214 may prevent (and sometimes eliminate) water, seeds, seed treatment formulation, etc. from escaping from the mixing chamber 116 when the door assembly 1200 is coupled to the seed treatment device 102 of FIGS. 1-2.

In the example of FIGS. 12-13, the seal brackets 1216, 1218 may be adjustable brackets formed of stainless steel such as 316 stainless steel, hardened stainless steel, etc. For example, and as shown in FIGS. 12-13, the seal brackets 1216, 1218 define multiple slotted openings 1230, 1232, respectively. In such examples, the slotted openings 1230, 1232 may be sized, shaped, and/or otherwise configured to allow horizontal movement of the seal brackets 1216, 1218 relative to the door 1202 by manipulating fastening devices 1228, thereby providing a more effective seal against the door 1202 (e.g., with the upper and lower seals 1212, 1214). With that said, it should be appreciated that the seal brackets 1216, 1218 may be fixed and/or formed of another suitable material such as, for example, aluminum, plastic, etc.

In various embodiments, the door seal assembly 1204 may include one or more spacer brackets to ensure the seals 1212, 1214 are positioned along upper and lower edge portions of the base member 1206. For example, and as shown in FIGS. 12-13, the door seal assembly 1204 includes spacer brackets 1220, 1222, 1224, 1226 positioned between the ledge members 1208, 1210 and the seal brackets 1216, 1218. Specifically, in the illustrated embodiment of FIGS. 12-13, the spacer bracket 1220 is positioned between the ledge member 1208 and the seal bracket 1216, thereby ensuring the seal 1212 is positioned along the upper edge portion of the base member 1206. Additionally, the spacer brackets 1222, 1224, 1226 are stacked between the ledge member 1210 and the seal bracket 1218, thereby ensuring the seal 1214 is positioned along the lower edge portion of the base member 1206. As shown, the spacer brackets 1220, 1222, 1224, 1226 are attached to the seal brackets 1216, 1218 via the fastening devices (e.g., bolts, screws, etc.) 1228. In the example of FIGS. 12-13, the spacer brackets 1220, 1222, 1224, 1226 may be formed of any suitable material such as stainless steel (e.g., 316 stainless steel, etc.), plastic (e.g., polyoxymethylene (POM) such as DELRIN®, acrylic, etc.). Although the door seal assembly 1204 is shown with a specific arrangement of spacer brackets, it should be appreciated that other embodiments may include more or less spacer brackets, different shaped spacer brackets, etc.

With continued reference to FIGS. 1-2, the housing 114 includes a generally cylindrical annular wall 124 that is coaxial with the vertical axis of the mixing chamber 116 and an upper annular flange 126. The annular flange 126 extends radially outward from an upper end of the annular wall 124 and transverse to the mixing chamber's vertical axis. The annular flange 126 is shaped and sized to correspond to an annular flange 128 of the body 108. As shown, one end of the housing 114 is coupled (e.g., detachably coupled, etc.) to the body 108 such that at least a portion of the rotor 110 is positioned within the housing 114. For example, the annular flange 126 of the housing 114 may be releasably coupled to the annular flange 128 of the body 108 with multiple pins, screws, bolts, clamps and/or other suitable mechanical attachment devices. The other opposing end of the housing 114 may be coupled (e.g., detachably coupled, etc.) to a shelf 130 (e.g., a metal plate, etc.) via in any suitable manner (e.g., one or more mechanical attachment devices, etc.).

The lid 112 is configured to be releasably coupled (e.g., mounted, secured, etc.) on the body 108 over an open upper end of the mixing chamber 116. For example, the lid 112 may be releasably coupled to the body 108 with multiple clamps and/or other suitable devices. When the lid 112 is coupled to the body 108, the lid 112 overlies and engages an upper flange 132 of the body 108 and covers the open upper end of the interior portion of the mixing chamber 116, thereby enclosing the mixing chamber 116.

As shown best in FIGS. 3-4, the lid 112 defines multiple inlet openings 134 for receiving or otherwise allowing the ingress of seed stock, treatment composition, finishing powders, and/or any additional materials used in a treatment process into the mixing chamber 116. In such examples, the inlet openings 134 are in fluid communication with the mixing chamber 116.

In the illustrated embodiment, the baffles 136 are coupled (e.g., fixedly coupled, detachably coupled, etc.) to the lid 112 and are disposed in the mixing chamber 116 when the lid is coupled to the body 108. The baffles 136 are configured (e.g., constructed, etc.) to redirect seeds and a treatment formulation in the device 102 when the rotor 110 rotates (in either direction), to thereby facilitate mixing of the seeds and coating of the seed treatment formulation on the seeds and/or removal of seed treatment formulation residue build-up within the mixing chamber 116. For instance, the baffles 136 may be shaped, sized, etc. in a manner conducive of catching the seeds and the treatment formulation and forcing/directing the seeds and the treatment formulation downward towards a bottom portion of the mixing chamber 116, to thereby facilitate mixing of the seeds and coating of the seed treatment formulation on the seeds and/or removal of seed treatment formulation residue in the mixing chamber 116. With that said, it should be appreciated that the baffles 136 may be coupled (e.g., detachably coupled, etc.) to another component of the device 102 such as, for example, the annular wall 122 of the body 108 and still redirect seeds and a treatment formulation in the device 102 when the rotor 110 rotates.

Additionally, the seed treatment device 102 may include a seed treatment applicator 121 with a portion that extends into the mixing chamber 116. In such examples, the seed treatment applicator 121 may be configured to dispense seed treatment formulation into the mixing chamber 116. For example, the seed treatment applicator 121 may dispense the seed treatment formulation while the rotor 110 is stationary or rotating. Accordingly, the seed treatment applicator 121 may dispense treatment formulation onto the seeds while the seeds are stationary or flowing within the mixing chamber 116. The seed treatment applicator 121 may be fluidly connected to a source of seed treatment formulation (not shown).

In the illustrated embodiment, the seed treatment applicator 121 includes a rotating plate 123 (as shown in FIG. 2) near the center of the mixing chamber 116 and configured to radially throw the treatment formulation onto the seeds. The rotating plate 123 may be driven or otherwise controlled by the driver used to rotate the rotor 110. Other configurations of the seed treatment applicator are within the scope of the present disclosure. For example, the seed treatment applicator may dispense the treatment into the mixing chamber 116 via a sprayer, curtain, sheet, or fan that can create a more uniform and faster initial distribution of treatment formulation between seeds than, for example, a rotating plate. For example, in one embodiment, the seed treatment applicator may include a spray applicator configured to spray the seeds that have spread out over the surfaces defining the mixing chamber (e.g., onto a bed of the seeds, etc.) via the centrifugal forces imparted by the rotor 110 to achieve a more uniform initial distribution of treatment formulation. Still, in another embodiment, the seed treatment applicator may include multiple treatment distribution heads (e.g., treatment outlets, etc.) that extend into the seeds contained within the mixing chamber 116 (e.g., into the seed volume, etc.) and deliver the seed treatment formulation directly into the seed volume. Such a seed treatment applicator may be desirable in large treatment loading conditions (such as 50 or more fluid ounces of treatment per 100 lbs. of seed, etc.) to achieve a high degree of initial seed-to-seed treatment uniformity. A more uniform initial distribution of treatment formulations between seeds results in a more uniform final distribution of treatment formulation over the seeds when the seed treating process (e.g., mixing and drying, etc.) is completed. Other configurations of the seed treatment applicator are within the scope of the present disclosure. Moreover, other devices for delivering treatments are also possible.

With reference to FIGS. 1-6, the fluid delivery assembly 104 generally includes a cover plate 138, a sprayer assembly (or sprayer) 140, and a recovery assembly 142. As further explained below, the delivery assembly 104 is configured to provide (e.g., spray, deliver, etc.) fluid (e.g., water, cleaning fluid/solution, etc.) via the sprayer assembly 140 into the mixing chamber 116 of the seed treatment device 102, and then remove the fluid via the recovery assembly 142 from mixing chamber 116.

As shown best in FIGS. 2 and 6, the cover plate 138 generally includes opposing sides 184, 186 and an outer perimeter 182. When the cover plate 138 and the lid 112 are assembled with the seed treatment device 102, the side (or bottom side) 186 faces the mixing chamber 116 and the side (or top side) 184 opposes the mixing chamber 116. Additionally, the cover plate 138 defines multiple openings extending between the opposing sides 184, 186. For example, one of the openings of the cover plate 138 provides a pathway for a portion of the sprayer assembly 140 to pass therethrough and into the mixing chamber 116, and another one of the openings of the cover plate 138 provides a pathway for a portion of the recovery assembly 142 to pass therethrough and into the mixing chamber 116, as further explained below.

The cover plate 138 is configured to detachably couple to the lid 112 of the seed treatment device 102. For example, as shown best in FIGS. 3-4, the lid 112 includes an inner ring 144 defining an opening (or inlet) 146 and extending away from a top side 148 of the lid 112. And, the cover plate 138 may be positioned within the opening 146 of the lid 112 and detachably coupled to the ring 144. In such examples, the cover plate 138 may be detachably coupled to the ring 144 (broadly, the lid 112) via studs 150 attached to the ring 144, sealing flanges, and/or other suitable devices.

As shown in the illustrated embodiment, the outer perimeter 182 of the cover plate 138 has a size and shape that generally corresponds to the size and shape of the opening 146 of the lid 112. For example, and as shown in FIGS. 1-2 and 6, the outer perimeter 182 has a generally circular shape that corresponds to the generally circular shape of the opening 146. In other examples, the outer perimeter 182 and the opening 146 may have another suitable shape if desired.

The sprayer assembly 140 generally includes a spray arm 152 and a spray nozzle 154 attached to and in fluid communication with the spray arm 152. More specifically, the spray arm 152 is an elongated member (e.g., a hollow rod, a tube, etc.) with a portion extending through one of the openings of the cover plate 138 and into the mixing chamber 116 when the cover plate 138 is coupled to the lid 112 and the lid 112 is coupled to the seed treatment device 102. The spray nozzle 154 is attached to the spray arm 152 at or near an end of the spray arm 152 located in the mixing chamber 116. With that said, the sprayer assembly 140 may include additional spray nozzles attached to the spray arm 152, and/or the spray nozzle 154 may be attached to another portion of the spray arm 152, if desired.

The sprayer assembly 140 is configured to spray fluid into the mixing chamber 116, thereby cleaning the mixing chamber 116 of residual seed treatment and seeds. For example, and as further explained below, fluid flows through an inlet 161 of the sprayer assembly 140, through an interior channel of the spray arm 152, and exits from one or more openings of the spray nozzle 154. The spray nozzle 154 is configured to generate a high-pressure helical fluid pattern through rotation of the spray arm 152 (further explained below). In various embodiments, fluid entering the mixing chamber 116 may have a pressure between about 50 PSI and about 150 PSI, or more or less. In some instances, fluid entering the mixing chamber 116 may have a pressure of about 70 PSI or another suitable generally low-pressure level to ensure the fluid does not damage the mixing chamber 116 and/or other components of the seed treatment device 102.

In various embodiments, portions of the sprayer assembly 140 is movable. More specifically, in the illustrated embodiment of FIGS. 1-2 and 6, the spray arm 152 and the spray nozzle 154 are movable in a linear direction along a longitudinal axis of the spray arm 152. For example, and as shown best in FIG. 6, the sprayer assembly 140 includes a slide bar 160 and a movable trolley 156 coupled to the spray arm 152 via fasteners 158. The slide bar 160 is coupled (e.g., bolted or otherwise attached, etc.) to a treater frame assembly 262 (e.g., a frame member 268 of the treater frame assembly 262, as further explained below; etc.). As such, in this example, the slide bar 160 is stationary (e.g., non-movable, fixed, etc.). The trolley 156 is coupled to the slide bar 160 and configured to move (e.g., linearly, etc.) along the slide bar 160. In such examples, the trolley 156 may be manually moved (e.g., by a user), automatically moved (e.g., via pneumatic connections), etc. For example, the trolley 156 may include one or more brackets defining a channel. With this configuration, the trolley 156 may be coupled to and movable relative to the slide bar 160 by positioning the slide bar 160 in the channel and the one or more brackets at least partially around the slide bar 160. As such, when the trolley 156 moves along the slide bar 160, the spray arm 152 coupled to the trolley 156 also moves in a linear direction perpendicular to the cover plate 138. This allows the spray arm 152 to descend into the mixing chamber 116 for cleaning of the mixing chamber 116 and then retract after cleaning (so as not to impact seed coating and/or treating during operation of the seed treatment device 102). In various embodiments, the movement of the trolley 156 may allow the spray arm 152 to controllably descend into the mixing chamber 116 and retract as desired, thereby directing (or focusing) water sprayed by the spray nozzle 154 at a particular area (e.g., an area of seed and/or seed treatment formulation residue, etc.) in the mixing chamber 116.

Additionally, the sprayer assembly 140 may include a brake mechanism to stop movement of the spray arm 152 (and by extension the spray nozzle 154) at a desired location within the mixing chamber 116. For example, and as shown best in FIG. 6, the trolley 156 includes controllable brakes 162 configured to engage the slide bar 160, thereby preventing (or inhibiting) the spray arm 152 (coupled to the trolley 156) from descending into the mixing chamber 116 beyond a defined distance relative to the cover plate 138. The defined distance may vary depending on, for example, the depth of the mixing chamber 116, location(s) of seed and/or treatment formulation build-up in the mixing chamber 116, etc. In such examples, the brakes 162 may be mechanical latches manually manipulated by a user to engage the slide bar 160 as shown in FIG. 6. In other examples, the brakes 162 may be controlled by a controller to engage the slide bar 160.

In the illustrated embodiment, the spray arm 152 of the sprayer assembly 140 may be configured to rotate within the mixing chamber 116 when the cover plate 138 and the lid 112 are coupled to the seed treatment device 102. For example, and with reference to FIGS. 1 and 6, the sprayer assembly 140 includes a motor 164 coupled to the spray arm 152 and configured to drive and control rotation of the spray arm 152. More specifically, the motor 164 (e.g., a rotary motor, a rotary air motor, etc.) is coupled to (or near) an end of the spray arm 152 located outside the mixing chamber 116. In such examples, the motor 164 may be controlled (e.g., pneumatically controlled, etc.) to cause full rotation (360-degree rotation) of the spray arm 152, thereby ensuring the spray nozzle 154 sprays water in all directions within the mixing chamber 116.

Although the spray arm 152 is illustrated and described as being movable in a generally vertical direction in FIGS. 1-2 and 6, it should be appreciated that the spray arm 152 may be movable in an angular direction in other example embodiments (e.g., to accommodate existing equipment located above and/or adjacent the treatment device 102, etc.). In such embodiments, for instance, the slide bar 160 may be oriented at an angle (e.g., about ten degrees, about twenty degrees, about thirty degrees, about forty degrees, about fifty degrees, about sixty degrees, about seventy degrees, about eighty degrees, at angles therebetween, angles less than about ten degrees, at angles greater than about eighty degrees, etc.). And, the trolley 156 may then be configured to move along the slide bar 160 as generally described above. Further, in some embodiments, the spray arm 152 may be movable relative to the mixing chamber 116 by pivoting the spray arm 152. For instance, the spray arm 152 may be pivotally coupled to the cover plate 186 (or lid 112, or other part of the seed treatment device 102, etc.) and configured to pivot into and out of the mixing chamber 116. That said, it should be appreciated that the spray arm 152 may be oriented in still other manners, for example, to accommodate available spacing above and/or adjacent the seed treatment device 102, and still be operable to move into and out of the mixing chamber 116, as desired, and still operate as described herein.

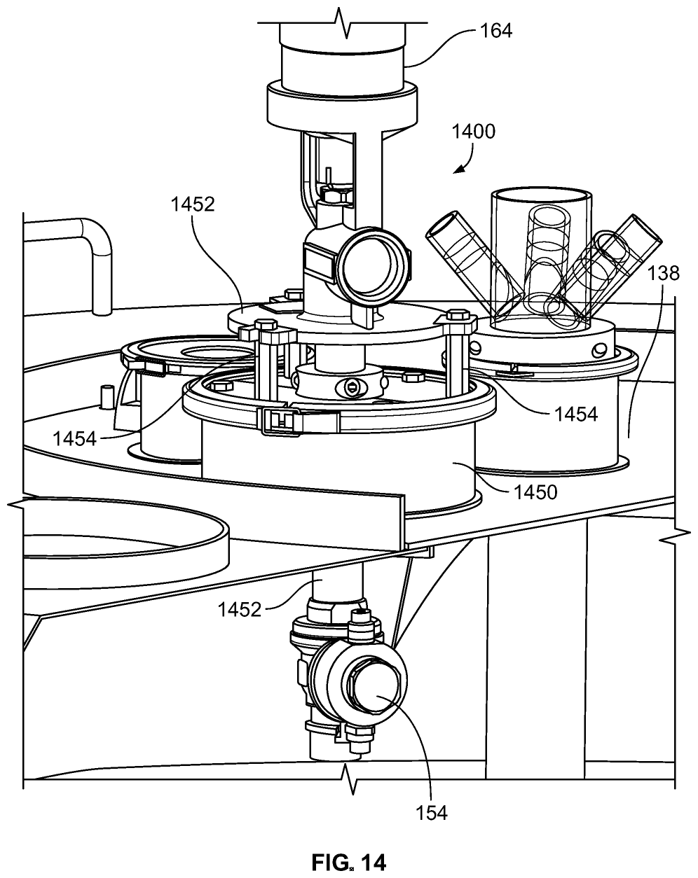

In addition, although the spray arm 152 is illustrated and described as being movable in a linear direction in FIGS. 1-2 and 6 to provide for a retractable assembly, it should be appreciated that in other embodiments the spray arm 152 and/or other spray arms herein may be stationary in a linear direction. In such examples, the spray arm 152 may be attached to a portion of the cover plate 138 in a manner to prevent linear movement. For instance, FIG. 14 illustrates an example sprayer assembly 1400 for use in a seed treatment device such as the seed treatment device 102 of FIGS. 1-2. The sprayer assembly 1400 is substantially similar to the sprayer assembly 140 of FIGS. 1-2 and 6, but includes a shorter spray arm and in which the spray arm is stationary in a linear direction.

The sprayer assembly 1400 of FIG. 14 generally includes spray arm 1452 and the spray nozzle 154 of FIG. 2 attached to and in fluid communication with the spray arm 1452. The spray arm 1452 is similar to the spray arm 152 of FIGS. 1-2 and 6. For example, the spray arm 1452 includes an elongated member (e.g., a hollow rod, a tube, etc.) with a portion extending through the cover plate 138 and into the mixing chamber 116 when the sprayer assembly 1400 is coupled to the seed treatment device 102 of FIGS. 1-2. However, the spray arm 1452 of FIG. 14 is shorter than the spray arm 152. For example, the spray arm 1452 may have a length between about 4 inches and about 8 inches, or more or less. In some embodiments, the length may be about 6 inches. With this arrangement, a relatively small portion of the spray arm 1452 may extend above the cover plate 138, thereby providing space for other systems such as dust collection systems, etc. usable with a seed treatment device (e.g., the seed treatment device 102 of FIGS. 1-2, etc.), a seed treatment system (e.g., the seed treatment system 100 of FIGS. 1-2, etc.).

In the illustrated embodiment of FIG. 14, the spray arm 1452 is fixed or stationary in a linear direction. For example, and as shown in FIG. 14, the spray arm 1452 is attached to a fitting 1450 of the cover plate 138 via a mounting plate 1452 and legs 1454. With this arrangement, the spray arm 1452 and the spray nozzle 154 attached thereto are stationary in that they are not movable in the linear direction. As such, the spray arm 1452 does not move (e.g., descend further, retract, etc.) in the mixing chamber 116 when the sprayer assembly 1400 is coupled to the seed treatment device 102 of FIGS. 1-2. While the spray arm 1452 is described and shown as being stationary in a linear direction in FIG. 14, in other embodiments the spray arm 1452 may be moveable if desired.

Further, the spray arm 1452 may be configured to rotate in a similar manner as the spray arm 152 of FIGS. 1-2 and 6 explained above. For example, the sprayer assembly 1400 may include the motor 164 of FIGS. 1 and 6 coupled to the spray arm 1452 and configured to drive and control rotation of the spray arm 1452, as explained above.

With continued reference to FIGS. 1-2, the recovery assembly 142 generally includes a recovery wand 166 and a hose (or suction hose) 168 attached to the recovery wand 166. More specifically, the recovery wand 166 is an elongated member (e.g., a hollow rod, a tube, etc.) extending into the mixing chamber 116 when the cover plate 138 and the lid are coupled to the seed treatment device 102. For example, and as shown best in FIGS. 2 and 5-6, the recovery wand 166 includes opposing open ends 170, 172, with the open end 170 positioned in the mixing chamber 116 when the cover plate 138 and the lid are coupled to the seed treatment device 102. The open end 172 of the recovery wand 166 may be generally abutted against the side (or the bottom side) of the cover plate 138, positioned in an opening of the cover plate 138, and/or passed through the opening of the cover plate 138. The recovery wand 166 may be held in place by a pull ring (or gasket) 174 extending around the recovery wand 166 near the open end 172. The hose 168 includes an open end 176 generally abutted against the side (or the top side) 184 of the cover plate 138, positioned in the opening of the cover plate 138, and/or passed through the opening of the cover plate 138. In such examples, the hose 168 and the recovery wand 166 may be attached in or near the opening of the cover plate 138, such that the open end 176 of the hose 168 and the open end 172 of the recovery wand 166 are in fluid communication. The hose 168 may be attached to the top side 184 of the cover plate 138 via a cover plate 180 and a gasket 178.

In the illustrated embodiment, the recovery wand 166 may extend a defined distance from the cover plate 138. In various embodiments, it may be desirable for the recovery wand 166 to extend to or substantially near the base 118 of the rotor 110 (or the bottom of the mixing chamber 116). As such, in such embodiments, the defined distance may vary, depending on, for example, the depth of the mixing chamber 116. For example, the defined distance may be substantially equal to (or slightly less than) the depth of the mixing chamber 116 such as a distance between the bottom side 186 of the cover plate 138 and the base 118 of the rotor 110. In other examples, the recovery wand 166 may extend another suitable distance into the mixing chamber 116.

The recovery wand 166 is configured to retrieve fluid from the mixing chamber 116 of the seed treatment device 102. For example, and as further explained below, after and/or while fluid is provided (e.g., sprayed, etc.) into the mixing chamber 116 and after the mixing chamber 116 is sufficiently cleaned of residual seed treatment and seeds, the recovery wand 166 may be employed to retrieve spent fluid and the residual seed treatment and seeds from the mixing chamber 116. In such examples, the recovery wand 166 may be in fluid communication with a vacuum source that creates a vacuum, thereby causing the recovery wand 166 to draw (or pull) the spent (or grey) fluid and the residual seed treatment and seeds from the mixing chamber 116.

In addition, in the illustrated embodiment, the fluid delivery assembly 104 further includes an imaging module 279 (e.g., at least one camera, lighting, etc.) configured to capture images of the interior portion of the mixing chamber 116. In doing so, the imaging module 279 (and/or image data captured by the imaging module 279) may be used to monitor status and/or buildup of residual seed treatment and/or seeds (and treatment thereof) in the mixing chamber 116. As illustrated, the imaging module 279 is coupled to (or mounted to) the bottom side 186 of the cover plate 138. However, the imaging module 279 may be located otherwise within the scope of the present disclosure (e.g., coupled to an inner surface of the lid 112, coupled to an inner surface of the mixing chamber 116, suspended within the mixing chamber 116, etc.).

Moreover, the imaging module 279 is in communication with controller assembly 252, for example, as described more hereinafter, whereby image data captured by the imaging module 279 may be transmitted to the controller assembly 252. In doing so, the controller assembly 252 may use the image data to monitor buildup of residual seed treatment in the mixing chamber 116 and to initiate (e.g., automatically, etc.) cleaning (e.g., a cleaning cycle, etc.) of the mixing chamber 116, etc. when needed (e.g., based on a threshold amount of residual seed treatment present in the mixing chamber 116, based on an unacceptable amount of buildup within the mixing chamber 116, etc.). Further, the image data may be used by the controller assembly 252 to determine whether a cleaning cycle of the mixing chamber 116 was successful, or if it needs to be repeated (e.g., a threshold amount of residual seed treatment is still present in the mixing chamber 116 after cleaning, an unacceptable amount of residual seed treatment buildup remains within the mixing chamber 116 after cleaning, etc.). Moreover, the image data may be used by the controller assembly 252 to determine a condition of the cleaning solution within the mixing chamber 116, and whether the cleaning solution should be replaced, etc.

As shown in FIGS. 1 and 7-10, the fluid supply assembly 106 generally includes an air lubricator 280, an air filter 282, a tank assembly 188, a pump assembly 190, and a vacuum source 192. As further explained below, the fluid supply assembly 106 is configured to couple to (e.g., releasably couple to, etc.) the fluid delivery assembly 104 and pump fluid from the tank assembly 188 with the pump assembly 190 to the mixing chamber 116 (via the spray arm 152 and the spray nozzle 154 of the fluid delivery assembly 104), and then draw (or pull) fluid from the mixing chamber 116 via the vacuum source 192.

The air lubricator 280 and the air filter 282 are in fluid communication with the motor 164. For example, compressed air may be provided from a source, such as an air compressor (not shown) and passed through the air filter 282 to the motor 164 of the fluid delivery assembly 104, to thereby pneumatically drive rotation of the motor 164. Additionally, the air lubricator 280 may provide a lubricant (e.g., oil, etc.) to the motor 164 to improve performance and reduce wear of the motor 164.

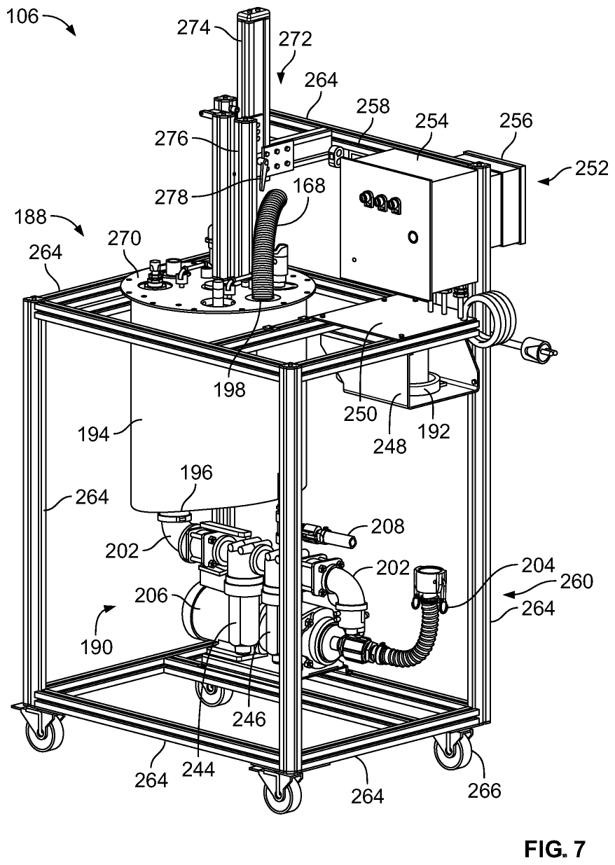

As shown best in FIGS. 7-10, the tank assembly 188 generally includes a tank (or a fluid storage tank) 194 having a lid 270, an outlet 196 and an inlet 198, a hose 202 coupled to the outlet 196, and the hose (or suction hose) 168. The tank 194 is in fluid communication with the spray arm 152 and the recovery wand 166. For example, the inlet 198 of the tank 194 is coupled to the recovery wand 166 via the hose (or suction hose) 168 (e.g., releasably coupled thereto via quick connect couplings, etc.). As such, fluid (or spent fluid) drawn from the mixing chamber 116 via the recovery wand 166 is passed through the hose 168 and into the tank 194. Additionally, the outlet 196 of the tank 194 is coupled to the pump assembly 190 via hoses 202, 204, and the pump assembly 190 is coupled to the spray arm 152 (as further explained below) (e.g., releasably coupled thereto via quick connect couplings, etc.). As such, fluid stored in the tank 194 may be pumped from the tank 194 with the pump assembly 190, passed through the spray arm 152 (and the spray nozzle 154), and then provided (or sprayed) into the mixing chamber 116.

The tank assembly 188 further includes a lid assembly 272 configured to move (e.g., vertically, etc.) the lid 270 of the tank 194 between a seated position on the tank 194 and an unseated position away from the tank 270. For example, and as shown in FIGS. 7-10, the lid assembly 272 includes a slide bar 274, a trolley 276, and controllable brakes 278. The slide bar 274, the trolley 276, and the controllable brakes 278 of the lid assembly 272 may function in a similar manner as the slide bar 160, the trolley 156, and the controllable brakes 162 of the sprayer assembly 140 explained above. For example, the slide bar 274 is coupled (e.g., bolted or otherwise attached) to a cleaning frame assembly 260 (e.g., a frame member 264 of the cleaning frame assembly 260, as further explained below). The trolley 276 is coupled to the lid 270 and the slide bar 274, and is configured to move (linearly) in a controlled manner along the slide bar 274, as explained above with respect to the slide bar 160 and the trolley 156 of the sprayer assembly 140. This allows the lid 270 (coupled to the trolley 276) to linearly move up and down along the slide bar 274. The controllable brakes 278 are configured to engage the slide bar 274, thereby preventing (or inhibiting) movement of the slide bar 274 and the lid 270.

In the illustrated embodiments, the tank 194 is configured (e.g., sized, shaped, etc.) to store desired fluid. For example, the tank 194 includes a base, a top wall, and an outer wall extending circumferentially around outer perimeters of the base and the top wall and between the base and the top wall. The base, the top wall, and the outer wall of the tank define an area for storing fluid (e.g., 20 gallons of fluid, more or less than 20 gallons of fluid, etc.). With that said, it should be appreciated that the tank 194 may be shaped differently, include different walls, and/or include internal reservoirs (or chambers) as desired to achieve the features described herein (e.g., storing fluid, etc.).

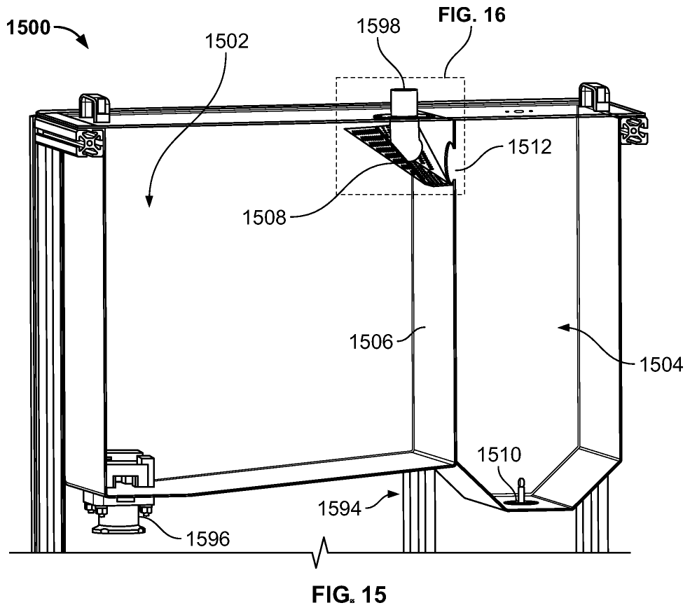

For example, FIG. 15 illustrates an example tank assembly 1500 that may be used in connection with a fluid supply assembly such as the fluid supply assembly 106 of FIGS. 7-10. As shown, the tank assembly 1500 of FIG. 15 generally includes a tank 1594 having an outlet 1596, and an inlet 1598. In the example of FIG. 15, the inlet 1598 may be coupled to, for example, the hose 168 of FIGS. 7-10 for receiving retrieved spent (or grey) fluid with residual seed treatment and seeds from the mixing chamber 116, and the outlet 1596 may be coupled to, for example, the hose 202 of FIGS. 7-10 for providing fluid to the pump assembly 190 of FIGS. 7-10, as explained herein.

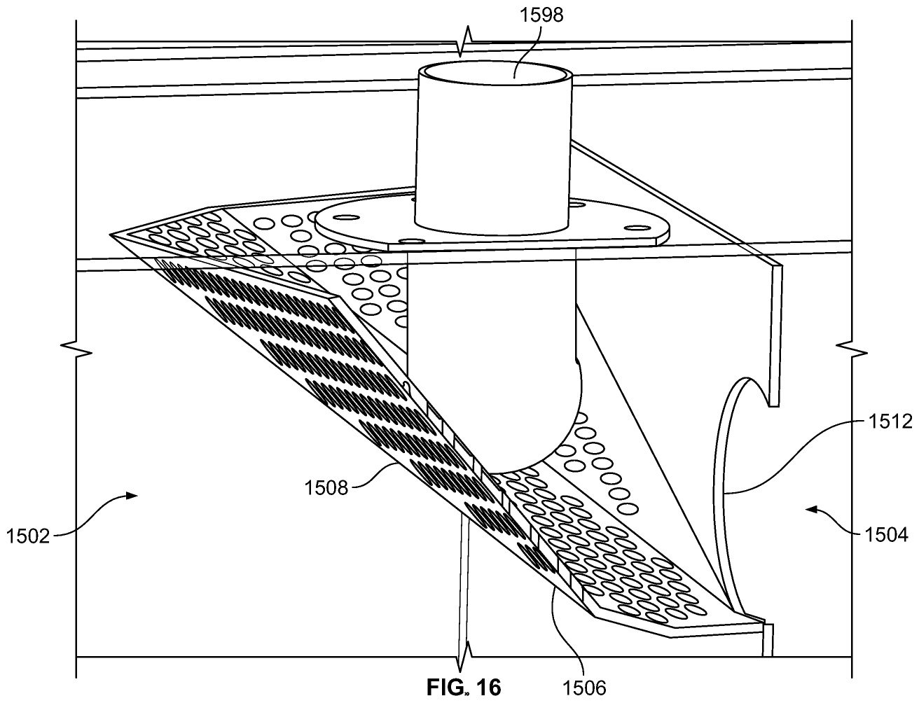

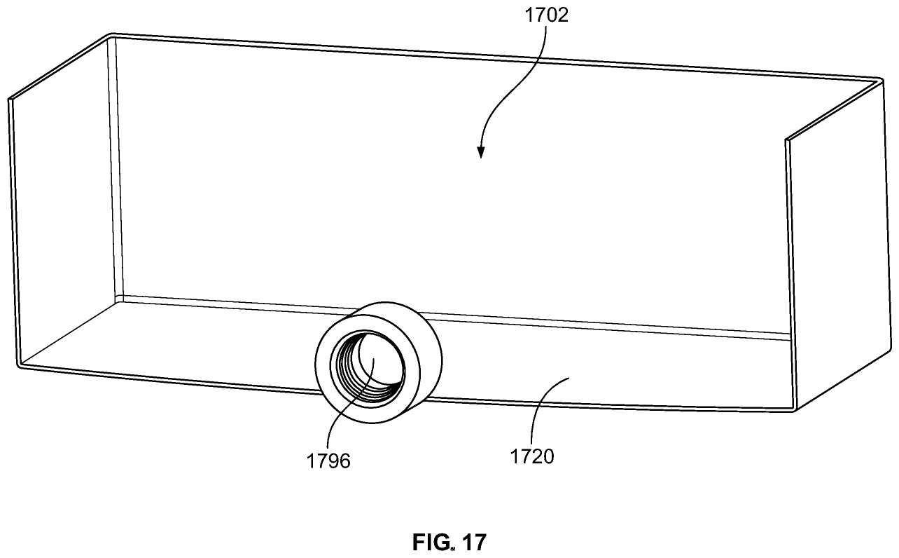

As shown, the tank 1594 is sectioned into two reservoirs 1502, 1504 separated by a wall 1506. In the illustrated embodiment of FIG. 15, the reservoir 1502 is configured to store spent (or grey) fluid and the reservoir 1504 is configured to store residual seed treatment and seeds. More specifically, and as shown in FIGS. 15-16, the tank assembly 1500 includes a filter 1508 positioned below the inlet 1598. The filter 1508 is arranged (e.g., positioned, sized, etc.) to strain at least a portion of the residual seed treatment and seeds from the spent fluid received through the inlet 1598. For example, when the spent fluid including residual seed treatment and seeds is passed through the inlet 1598, the filter 1508 strains at least a portion of the residual seed treatment and seeds (or solid waste) from the spent fluid and funnels the strained residual seed treatment and seeds into the reservoir 1504 via an opening 1512 in the wall 1506. The filter 1508 allows the spent fluid (without solid waste) to pass therethrough and into the reservoir 1502. The solid waste can then be removed as desired via an outlet (or opening) in the bottom of the reservoir 1504 by actuating a valve 1510 (e.g., a pancake valve, etc.). In such examples, the solid waste in the reservoir 1504 can be removed via a vacuum, gravity, a clean out process, a macerating mechanism, etc. As such, the arrangement of the reservoirs 1502, 1504 and the filter 1508 allows for easy containment and disposal of solid waste from the tank assembly 1500.

The filter 1508 of FIGS. 15-16 is a meshed plate structure shaped and positioned to funnel the strained solid waste into the reservoir 1504. More specifically, the plate structure is sloped towards the opening 1512 in the wall 1506 to allow the strained solid waste to move towards and fall into the reservoir 1504 due to gravity. In such examples, the filter 1508 may have a 50-mesh size, a 100-mesh size, and/or another suitable size depending on, for example, the size of the retrieved residual seed treatment and seeds. Additionally, the filter 1508 may be replaceable with another filter having a different mesh size as desired. While the filter 1508 is shown in FIGS. 15-16 and described with a specific shape and arrangement, other embodiments may include a differently shaped and/or arranged filter capable of achieving the features described herein.

In the example of FIG. 15, the reservoir 1502 has a generally quadrilateral shape with an angled bottom side generally sloped towards to the outlet 1596, and the reservoir 1504 has a generally pentagonal prism shape with an angled bottom side generally sloped towards to the outlet/valve 1510. With this arrangement, the reservoir 1502 is able to store about twenty gallons of spent fluid and the reservoir 1504 is able to store about 5 gallons of solid waste. While the reservoirs 1502, 1504 are shown and described as having specific shapes, sizes, and placements of the outlets, it should be appreciated that the reservoir 1502 and/or the reservoir 1504 may have a different shape, size, outlets, etc. depending on, for example, design needs, available space, etc.

For example, FIG. 17 illustrates a portion of a reservoir 1702 (broadly a tank) usable for storing spent fluid in connection with the tank assembly 1500 and/or other tank assemblies herein. The reservoir 1702 is similar to the reservoir 1502 of FIG. 15, but includes an outlet 1796 extending from a side wall (not shown in FIG. 17 for clarity) of the reservoir 1702. More specifically, the outlet 1796 extends from the side wall at a bottom 1720 of the reservoir 1702.

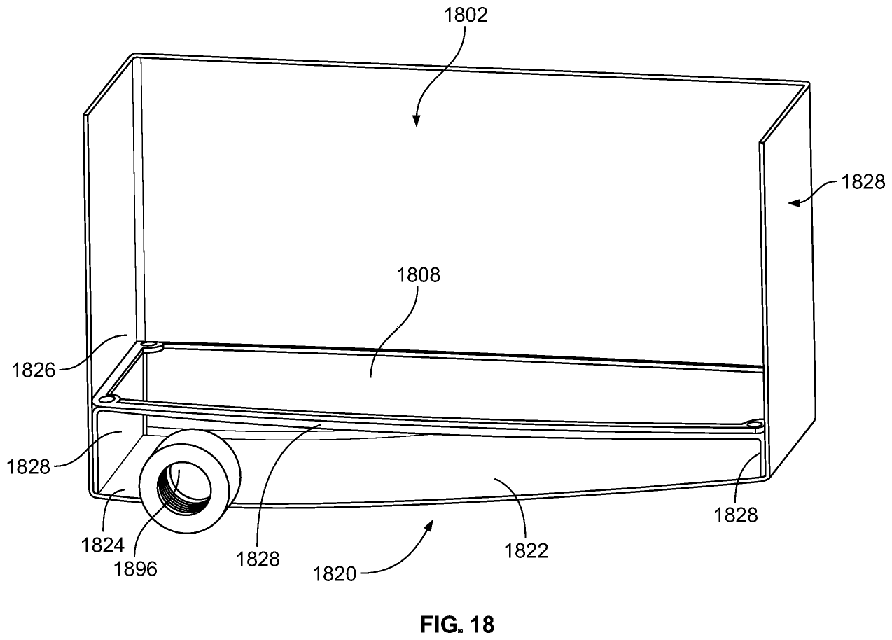

Additionally, FIG. 18 illustrates a portion of another example reservoir 1802 (broadly a tank) usable for storing spent fluid in connection with the tank assembly 1500 and/or other tank assemblies herein. The reservoir 1802 is similar to the reservoir 1502 of FIG. 15, but includes an outlet 1896 extending from a side wall (not shown in FIG. 18 for clarity) of the reservoir 1802. More specifically, the reservoir 1802 includes a bottom 1820 and opposing side walls 1826, 1828 extending from the bottom 1820. As shown, the bottom 1820 includes a generally angled wall portion 1822 extending from the side wall 1828 and sloped towards the outlet 1896, and a generally flat wall portion 1824 extending between the angled wall portion 1822 and the side wall 1826. The outlet 1896 then extends from the side wall (not visible) at the wall portion 1824 of the bottom 1820 and near the side wall 1826 of the reservoir 1802. With this arrangement, spent fluid in the reservoir 1802 is able to drain from the reservoir 1802 (via the outlet 1896) with gravity.

In various embodiments, the reservoir 1802 may include a filter for straining solid waste (e.g., residual seed treatment, seeds, etc.) from the spent fluid. For example, the reservoir 1802 of FIG. 18 includes a filter 1808 extending between the side walls 1826, 1828 and above the bottom 1820. As shown, the filter 1808 is supported by a filter mount 1828 extending from the bottom 1820 and between the side walls 1826, 1828 of the reservoir 1802. In such examples, the filter 1808 may be removable/replaceable and have a 50-mesh size, a 100-mesh size, and/or another suitable size depending on, for example, the size of the retrieved residual seed treatment and seeds. While the reservoir 1802 is shown as including the filter 1808, it should be appreciated that in other embodiments, the reservoir 1802 may not include the filter 1808 and/or include a different filter (e.g., a different sized, shaped, arranged, etc. filter).

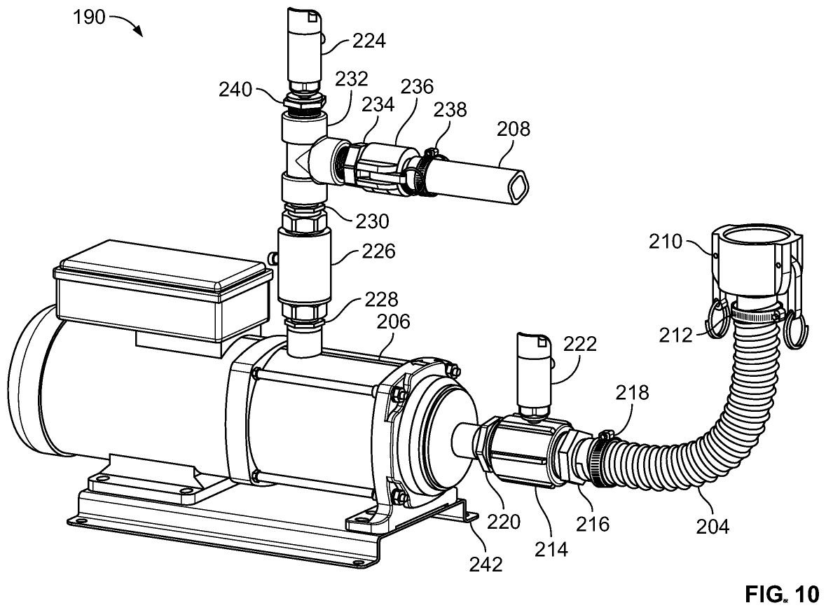

With continued reference to FIGS. 7-10, the pump assembly 190 generally includes a pump 206, a pump mount 242 for supporting the pump 206, hoses 204, 208, and various sensors. As shown, in the example embodiment, the sensors include two pressure sensors 222, 224 and a flow meter 226, and the pump 206 of FIG. 10 is a centrifugal pump. Although the pump assembly 190 is shown and described as having a specific number and specific types of sensors, and a specific type of pump, it should be appreciated that more or less sensors (and sometimes no sensors) may be employed, different types of sensors may be employed, and/or a different type of pump may be employed without departing from the scope of the disclosure. In connection therewith, the data captured by the various sensors and/or the imaging module 279 may be used to provide warnings or alarms (e.g., via the controller assembly 252, visually or audibly; etc.) to a user, for example, indicating one or more issues with a feature and/or operation of the seed treatment system 100 (e.g., low fluid volume, low or high pressure limits, clogged valves, filter replacement necessary, cleaning cycle not successful, cleaning fluid needs replacement, etc.).

The hose 204 is coupled to the pump 206 for providing water from the tank assembly 188 to the pump 206. For example, although not shown, the hose 204 is coupled between the hose 202 of the tank assembly 188 and the pump 206. More specifically, the hose 204 is coupled to the hose 202 of the tank assembly 188 via a coupling cam 210 and a hose clamp 212. In such configurations, the coupling cam 210 is sized and shaped to receive a portion of the hose 202 and the hose clamp 212 extends around the hose 204 to secure it to the coupling cam 210. Additionally, the hose 204 is coupled to the pump 206 via a pipe coupling 214, a hose barb 216, a hose clamp 218, and a reducing nipple 220. In such configurations, the pipe coupling 214 connects the hose 204 to the pump 206 (via the reducing nipple 220) and the hose clamp 212 extends around the hose 204 to secure it to the pipe coupling 214.

Additionally, the hose 208 is coupled to the pump 206 for providing fluid from the pump 206 to the sprayer assembly 140. For example, although not shown, the hose 208 is coupled (e.g., releasably coupled, etc.) between the pump 206 and the spray arm 152 of the sprayer assembly 140. More specifically, the hose 208 is coupled to the pump 206 via the flow meter 226, pipe nipples 228, 230 on opposing sides of the flow meter 226, a pipe tee 232, coupling cams 234, 236, and a hose clamp 238. With this configuration, the flow meter 226 is configured (e.g., through conventional flow sensing procedures, etc.) to sense a rate of fluid leaving the pump 206 and passing through the coupling tee 232 and the hose 208. Additionally, the coupling cam 236 is sized and shaped to receive a portion of the hose 208 and the hose clamp 238 extends around the hose 208 to secure it to the coupling cam 236. The hose 208 then extends to and connects (e.g., via a quick connector, etc.) with the spray arm 152 of the sprayer assembly 140.

With continued reference to FIG. 10, the pressure sensor 222 is coupled to the pipe coupling 214 and the pressure sensor 224 is coupled to the pipe tee 232 via a reducing bushing 240. As such, the pressure sensor 222 is configured (e.g., through conventional pressure sensing procedures, etc.) to sense a pressure of fluid passing through the hose 204 and the pipe coupling 214 and into the pump 206, and the pressure sensor 224 is configured (e.g., through conventional pressure sensing procedures, etc.) to sense a pressure of fluid leaving the pump 206 and passing through the coupling tec 232 and the hose 208. In various embodiments, the pressure sensors 222, 224 and/or the flow meter 226 may generate and output signals (e.g., feedback signals, etc.) to a controller for monitoring and controlling operations of the pump 206 and/or other components of the seed treatment system 100.

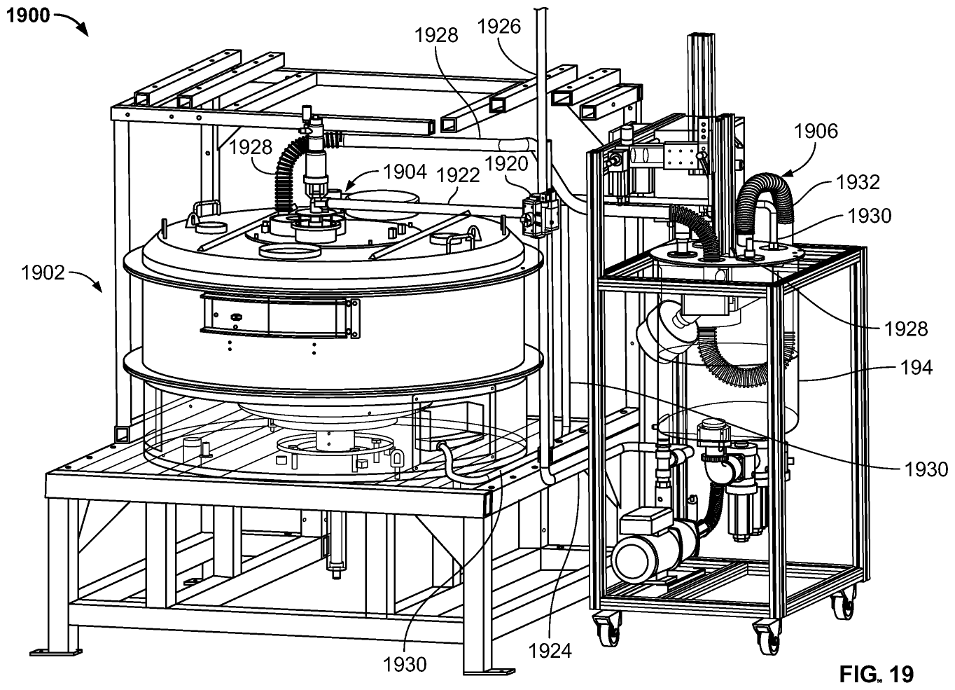

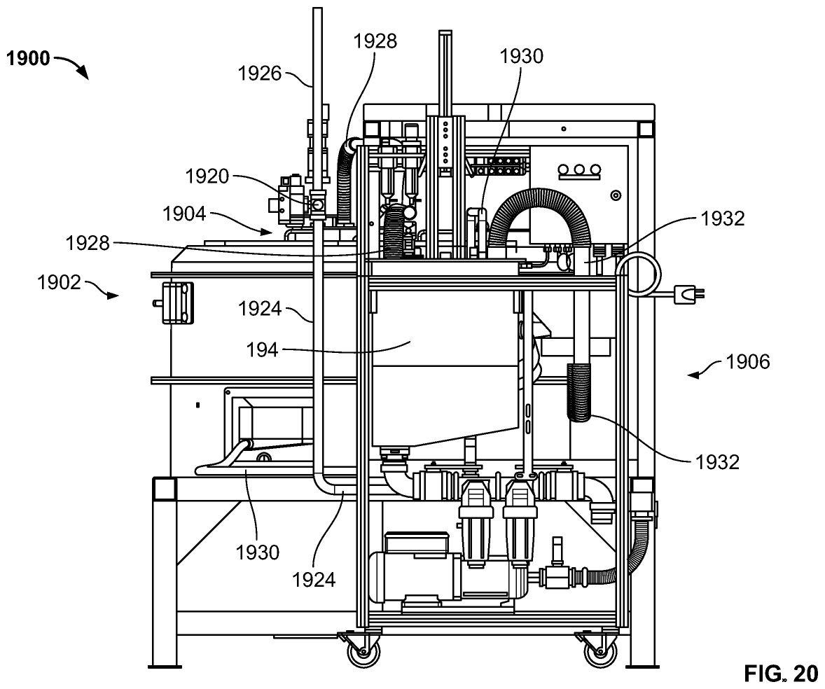

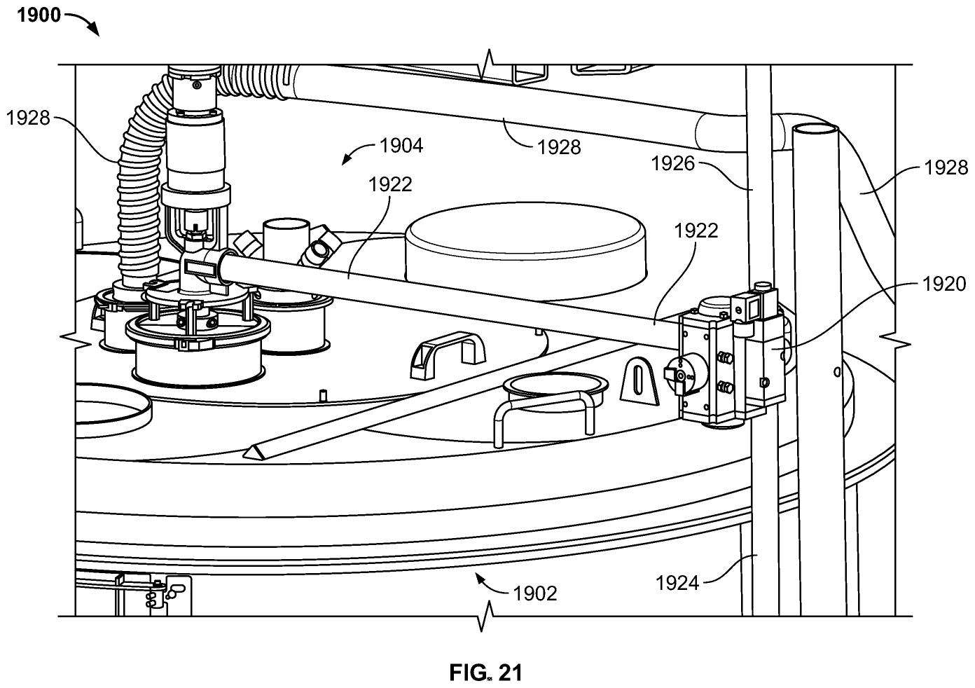

The vacuum source 192 is configured to create a vacuum in the tank 194 to draw fluid from the mixing chamber 116. For example, the vacuum source 192 may be a vacuum motor or another suitable device that is in fluid communication with the tank 194 via one or more hoses (e.g., the hose 1932 of FIGS. 19-21). The vacuum source 192 may create a vacuum in the tank 194 by drawing air from the tank 194 via the hose, thereby reducing the pressure in the tank 194 and causing the spent fluid (after cleaning the mixing chamber 116) to be drawn into the recovery wand 166 where it is passed to the tank 194 via the hose 168.

As shown, the vacuum source 192 is supported in a housing including mount brackets 248 and a cover plate 250. The mount brackets 248 may include one or more members for supporting the vacuum source 192 and attaching the mount brackets 248 to one or more frame members 264 (as further explained below). The cover plate 250 is attached to one or more of the mount brackets 248 and covers a top side of the vacuum source 192.

As shown best in FIGS. 7-10, the fluid supply assembly 106 further includes filters 244, 246 in fluid communication with the tank assembly 188 and the pump assembly 190. More specifically, the filters 244, 246 are coupled with the hose 202 extending from the tank 194 to the hose 204 (which extends to the pump 206). The filters 244, 246 may be conventional filters arranged in a tandem fashion to remove at least a portion of the residual seed treatment and seeds from the retrieved water passing from the tank 194 and through the pump 206. The filters 244, 246 may be any suitable size depending on, for example, the size of the seeds and chunks of seed treatment removed from the mixing chamber 116, the amount of filtering desired, etc. For example, one or both filters 244, 246 may have a 50-mesh size, a 100-mesh size, and/or another suitable size. In some embodiments, the filter 244 (which is closer to the tank 194 with respect to water flow) may have a 100-mesh size (or another suitable size) and the filter 246 (which is closer to the pump 206 with respect to water flow) may have a 50 mesh size (or another suitable size smaller than the size of the filter 244). Although the fluid supply assembly 106 is shown and described as including two filters of specific sizes and arrangements, it should be appreciated that the fluid supply assembly 106 may include more or less filters located in different portions of the assembly (e.g., an inlet side of the tank 194, etc.), filters of various different sizes, etc.

With continued reference to FIGS. 1 and 7-9, the seed treatment system 100 includes controller assembly 252 in communication with the seed treatment device 102, the fluid delivery assembly 104, and/or the fluid supply assembly 106. The controller assembly 252 generally includes a controller 254, a power supply 256, and a connection block 258. The connection block 258 generally includes terminals for providing connections for wires extending to and/or from the controller 254, the power supply 256, and/or other components of the seed treatment device 102, the fluid delivery assembly 104, and/or the fluid supply assembly 106.

The controller 254 may be configured to control (e.g., through executable instructions, etc.) operation of various components of the seed treatment device 102, the fluid delivery assembly 104, and/or the fluid supply assembly 106. Operations may be controlled based on, for example, the pressure sensors 222, 224 and the flow meter 226 of FIG. 10, data collected by the imaging module 279, other sensors in the system 100, user input, etc. For example, the controller 254 may control operation (e.g., turn on, turn off, speed, etc.) of the pump 206 of the fluid supply assembly 106 to pump fluid from the tank 194 (via the filters 244, 246) to the mixing chamber 116 (via the spray arm 152), and control operation (e.g., turn on, turn off, etc.) of the vacuum source 192 of the fluid supply assembly 106 to create a vacuum, thereby drawing fluid from the mixing chamber 116 and into the tank 194. Additionally, the controller 254 may control operation of the trolley 156 (and by extension the spray arm 152) of the fluid delivery assembly 104 to linearly move it within the mixing chamber 116 (e.g., with one or more actuators, etc.), the brakes 162 of the fluid delivery assembly 104 to prevent the spray arm 152 from moving beyond a defined distance (e.g., with one or more actuators, etc.), and the motor 164 of the fluid delivery assembly 104 to rotate the spray arm 152. Further, the controller 254 may control rotation (e.g., speed, direction, etc.) of the rotor 110 in the seed treatment device 102, and/or other components of the device 102 such as the door associated with an exit opening of the device 102, a seed delivery device for automatically delivering seeds to the device 102, a seed treatment applicator, etc. The controller 254 may also initiate cleaning operation of the mixing chamber 116 based on image data received from the imaging module 279 (e.g., image data indicating a buildup of residual seed treatment within the mixing chamber 116, etc.), or repeat cleaning operation based on image data received from the imaging module 279 (e.g., image data indicating that residual seed treatment still remains in the mixing chamber 116 following a cleaning cycle, etc.).

In various embodiments, the controller 254 may automate the cleaning of residual seed treatment and seeds in the mixing chamber 116. For example, through the controller 254, the pump 206, the vacuum source 192, etc. may be fully automated to provide fluid to the mixing chamber 116 and then retrieve fluid from the mixing chamber 116 (as explained herein) without direct user interaction. As such, cleaning of residual seed treatment and seeds in the mixing chamber 116 may occur during off-hours of a site (e.g., during the night, at breaks, etc.) without requiring a user (in Tyvek suit) to clean the mixing chamber 116.

The controller 254 may be any suitable type of control device. For example, in some embodiments, the controller may include a processor and memory coupled to (and in communication with) the processor. For example, the processor may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein. The memory may be one or more devices that permit data, instructions, etc., to be stored therein and retrieved therefrom. For example, the memory may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. Furthermore, in various embodiments, computer-executable instructions may be stored in the memory for execution by the processor to cause the processor to perform one or more of the operations described herein in connection with the various different parts of or in communication with the device 102, the assemblies 104, 106, and/or the system 100, such that the memory is a physical, tangible, and non-transitory computer readable storage media.

Additionally, while the illustrated embodiment shows the controller 254 as a single device for controlling multiple components, it should be appreciated that the system 100 may include multiple controllers which may (or may not) be in communication with each other. For example, the system 100 may include a controller (e.g., a dedicated controller, etc.) for controlling operations of the seed treatment device 102 and another controller (e.g., the controller 254, etc.) for controlling operations of the fluid delivery assembly 104 and the fluid supply assembly 106. In this manner, the fluid delivery assembly 104 and the fluid supply assembly 106 may be employable with various different seed treatment devices such as the seed treatment device 102.

The power supply 256 is configured to power one or more components in the system 100. For example, the power supply 256 may power the controller 254, the pump 206, the vacuum source 192, etc. The power supply 256 may be any suitable power source such as for example, an AC-DC inverter, a DC-DC converter, etc.

With continued reference to FIGS. 1-2 and 7-9, the seed treatment system 100 further includes one or more frame assemblies for supporting the device 102, the fluid delivery assembly 104 and/or the fluid supply assembly 106. For example, the system 100 generally includes a cleaning frame assembly 260 and a treater frame assembly 262.

The cleaning frame assembly 260 generally includes various frame members 264 and casters 266 attached to one or more of the frame members 264. The frame members 264 include multiple horizontal and vertical extending metal beams (or rails) for supporting components of the fluid supply assembly 106, such as the pump 206, the tank 194, the mount bracket 248 (and the vacuum source 192), the controller 254, the power supply 256, etc. In various embodiments, the pump 206, the tank 194, the vacuum source 192, the controller 254, the power supply 256, and/or other components may be attached (e.g., detachably coupled, etc.) to the frame members 264 via screws, bolts, nuts, etc. The casters 266 allow for easy movement of the cleaning frame assembly 260, as well as the fluid supply assembly 106. This allows a user to move the fluid supply assembly 106 to different locations (e.g., to locations of different seed treatment devices, to different sides of the seed treatment device 102, etc.). For instance, a user may disconnect the fluid supply assembly 106 from the fluid delivery assembly 104 (of the seed treatment device 102). The user may then move the fluid supply assembly 106 (via the casters 266, etc.) to another seed treatment device and connect the fluid supply assembly 106 to a fluid delivery assembly of that seed treatment device. In this way, the fluid supply assembly 106 provides a mobile unit that may be moved relative to the seed treatment device 102, that may be moved between different seed treatment devices, and/or that may be connected, disconnected, and reconnected to different seed treatment devices (and, in particular, to different fluid delivery assemblies associated with the different seed treatment devices) for use in cleaning the different seed treatment devices.

As described, the illustrated fluid supply assembly 106 is a mobile assembly. In connection therewith, the illustrated fluid supply assembly 106 includes casters 266 coupled to the frame members 264 of the cleaning frame assembly 260 allow for movement of the fluid supply assembly 106 as desired (and as generally described herein). That said, it should be appreciated that other means for moving the cleaning frame assembly 260 may be used in other example embodiments. For instance, the cleaning frame assembly 260 may include a track system configured to move the fluid supply assembly 106 to different locations, a rail system, a suspension system, etc.

As shown in FIGS. 1-2, the treater frame assembly 262 generally includes various frame members 268 and the shelf 130 (e.g., a metal plate, etc.). The frame members 268 include multiple horizontal and vertical extending metal beams (or rails) for supporting the shelf 130 and the seed treatment device 102 coupled to the shelf 130. In various embodiments, components of the sprayer assembly 140 such as, for example, the slide bar 160 may be detachably coupled to one of the frame members 268. Further, in some embodiments, one or more frame members 264 of the cleaning frame assembly 260 may be detachably coupled one or more frame members 268 of the treater frame assembly 262.

FIGS. 19-21 illustrate an example embodiment of a seed treatment system 1900 including one or more aspects of the present disclosure, for use in treating seeds, applying treatment formulations to seeds, and/or cleaning seed and/or treatment formulation build-up. The seed treatment system 1900 may be employable as part of a desired seed treatment system such as a continuous seed treatment system, etc. The system 1900 of FIGS. 19-21 includes similar components as the seed treatment system 100 of FIGS. 1-2. For example, and as shown in FIGS. 19-21, the system 1900 generally includes a seed treatment device (or a seed treater) 1902, a fluid delivery assembly 1904, and a fluid supply assembly 1906, each of which function in a similar manner as the seed treatment device 102, the fluid delivery assembly 104, and the fluid supply assembly 106.

As shown in FIGS. 19-21, the fluid delivery assembly 1904 is in fluid communication with the seed treatment device 1902, and the fluid supply assembly 1906 is in fluid communication with the fluid delivery assembly 1904. For example, the system 1900 includes multiple hoses (e.g., fluid tubes, pipes, etc.) for passing fluid between the seed treatment device 1902, the fluid delivery assembly 1904, and/or the fluid supply assembly 1906.

The fluid delivery assembly 1904 may receive fluid from multiple sources and then pass the fluid into the seed treatment device 1902 as explained herein. For example, and as shown in FIGS. 19-21, the system 1900 includes a valve 1920 (e.g., a three-way pneumatic valve, etc.) connecting the fluid delivery assembly 1904 to the fluid supply assembly 1906 and a water source (not shown). Specifically, a hose 1922 extends between an inlet of the fluid delivery assembly 1904 (e.g., the inlet 161 of the sprayer assembly 140 of FIG. 6) and the valve 1920, a hose 1924 extends between the valve 1920 and a pump of the fluid supply assembly 1906 (e.g., the pump 206 of the fluid supply assembly 106 of FIG. 10), and a hose 1926 extends between the valve 1920 and the water source. In such examples, the hose 1924 of FIGS. 19-21 may correspond to the hose 208 (coupled to the pump 206) of FIG. 10. During operation, the fluid delivery assembly 1904 receives fluid (e.g., recycled, recirculated, etc. water) from the pump of the fluid supply assembly 1906 via the hoses 1922, 1924, and fluid (e.g., clean water) via hoses 1922, 1926.

Additionally, the fluid supply assembly 1906 may receive fluid (e.g., spent fluid) from the seed treatment device 1902 and the fluid delivery assembly 1904 as explained herein. For instance, and as shown in FIGS. 19-21, the system 1900 includes a hose 1928 extending between the fluid delivery assembly 1904 and the fluid supply assembly 1906, and a hose 1930 extending between the seed treatment device 1902 and the fluid supply assembly 1906. In such examples, the hose 1928 may correspond to the hose 168 of FIGS. 1-2 and 6-9 and the hose 1930 may connect to an outlet of a reservoir usable for storing spent fluid (e.g., the outlet 1796, 1896 of the reservoir 1702, 1802 of FIGS. 17-18). During operation, the fluid supply assembly 1906 creates a vacuum to draw spent fluid (e.g., water) from the seed treatment device 1902 to the fluid supply assembly 1906 via the hoses 1928, 1930 as explained herein.

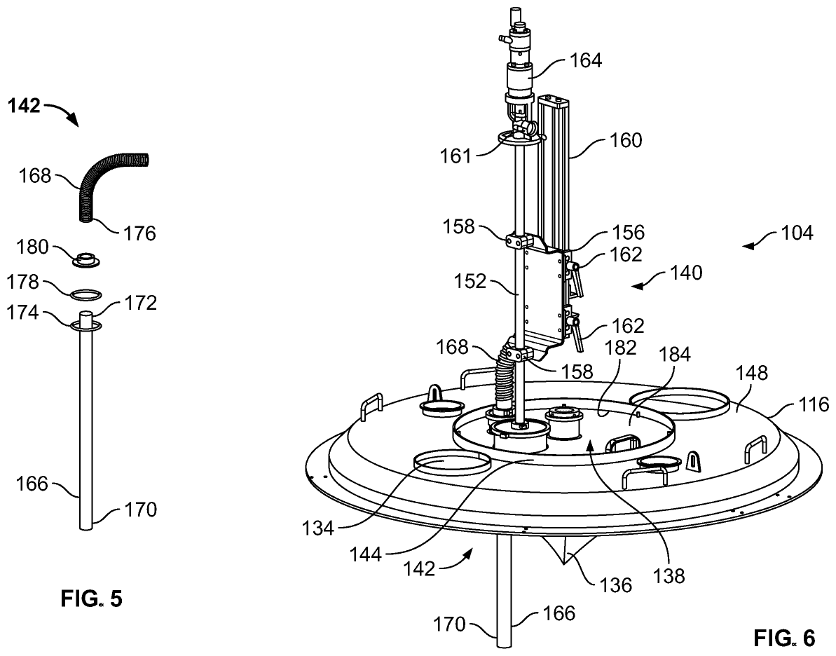

The fluid supply assembly 1906 creates a vacuum with a vacuum source and a hose 1932 coupled between the vacuum source and the tank 194. For example, and as explained herein, the vacuum source (e.g., the vacuum source 192 of FIGS. 7 and 9) is configured to create a vacuum in the tank 194 to draw fluid from the seed treatment device 1902. The vacuum source may create a vacuum in the tank 194 by drawing air from the tank 194 via the hose 1932, thereby reducing the pressure in the tank 194 and causing the spent fluid to be drawn into the recovery wand 166 of FIG. 5 where it is passed to the tank 194 via the hoses 1928, 1930.

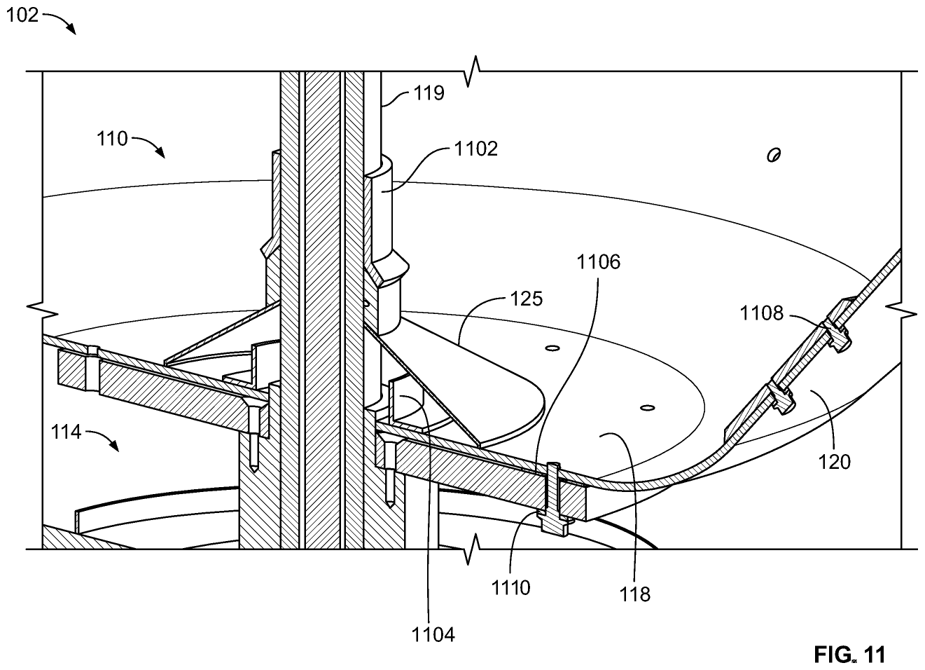

In various embodiments, existing seed treatment devices may be implemented with any one of the cleaning systems disclosed herein such as the cleaning system including the fluid delivery assembly 104, 1904 and the fluid supply assembly 106, 1906. In such examples, existing seed treatment devices may be retrofit with relatively minor modifications to accommodate the cleaning system. For example, FIG. 11 illustrates a portion of the seed treatment device 102 (e.g., the rotor 110 and the housing 114) of FIGS. 1-2, which in this example is an existing seed treatment device having minor modifications to accommodate the fluid delivery assembly 104 and the fluid supply assembly 106. For example, and as shown in FIG. 11, the modified device 102 includes a sealing sleeve 1102, a containment flange 1104, a gasket washer 1106, and sealing washers 1108, 1110. The sealing sleeve 1102 extends around the shaft 119 and abuts against the flange 125, the containment flange 1104 extends around the shaft 119 between the flange 126 and the base 118 of the rotor 110, and the gasket washer 1106 and the sealing washers 1108, 1110 are positioned in and/or near the base 118 and the side wall 120 of the rotor 110. With the arrangement of such components, fluid used to clean the mixing chamber 116 may be substantially prevented from leaking out of the mixing chamber 116.

With continued reference to FIGS. 1-2, cleaning of the seed treatment device 102 may begin after one or more seed treatments. For example, a seed treatment may conclude after seeds and seed treatment formulation(s) are loaded, delivered, etc. into the seed treatment device 102, mixed, and then at least partially removed from the seed treatment device 102. After the completion of at least one seed treatment, seed and/or seed treatment formulation residue may remain in the mixing chamber 116 (e.g., on the side wall 122 of the body 108, on the base 118 of the rotor 110, on the side wall 120 of the rotor, etc.).

In an effort to substantially clean the possible remaining seed and/or seed treatment formulation residue, a cleaning system such as the cleaning system of FIGS. 1-2 and 5-9 including the fluid delivery assembly 104 and the fluid supply assembly 106 may be coupled to the seed treatment device 102. To do so, the cover plate 138 is coupled to the lid 112 of the seed treatment device 102 by inserting, attaching, etc. the cover plate 138 in the opening 146 of the lid 112 such that the spray arm 152 and the recovery wand 166 extend into the mixing chamber 116.

Next, the pump 206 is activated to pump fluid stored in the tank 194 to the mixing chamber 116. More specifically, fluid is released from the tank 194, and then is passed through the hoses 202, 204, the pump 206, and the hose 208 to the spray arm 152 (connected to the hose 208). In some embodiments, the fluid may be passed through one or both filters 244, 246 located between the tank 194 and the pump 206. Then, the fluid is passed through the spray arm 152, out of the spray nozzle 154, and into the mixing chamber 116 to clean at least some (and sometimes all of the) seed and/or seed treatment formulation residue in the mixing chamber 116. As explained above, the spray arm 152 may be moved in linear directions (e.g., descended further into the mixing chamber 116 and/or retracted) to ensure a desired location of the spray nozzle 154 in the mixing chamber 116 and/or rotated (e.g., 360 degrees, etc.) to ensure fluid reaches desired portions of the mixing chamber 116.

Fluid exiting the spray nozzle 154 may have any suitable pressure level and/or flow rate. For example, fluid exiting the spray nozzle 154 (and entering the mixing chamber 116) may have a pressure ranging between about 50 PSI and about 150 PSI (e.g., due to the spray nozzle 154, etc.) and a flow rate ranging between about 2 gallons per minute and about 6 gallons per minute to sufficiently clean the mixing chamber 116. In some embodiments, fluid exiting the spray nozzle 154 (and entering the mixing chamber 116) may have a pressure of about 70 PSI and a flow rate of about 4 gallons per minute for about 7 minutes.

After a sufficient amount of time has passed (e.g., about 7 minutes, more or less than about 7 minutes, etc.) and/or a sufficient amount of fluid has been provided to the mixing chamber 116 to clean seed and/or seed treatment formulation residue in the mixing chamber 116, the pump 206 is deactivated and the vacuum source 192 is activated. The vacuum source 192, which is coupled to the recovery wand 166 located in the mixing chamber 116, creates a vacuum in the tank 194. This allows the recovery wand 166 to retrieve fluid (e.g., at about 130 CFM (about 1.5 PSI in vacuum), etc.) including seed and/or seed treatment formulation residue from the mixing chamber 116. The retrieved fluid is passed through the recovery wand 166 and provided to the tank 194. In some embodiments, the retrieved fluid may pass through one or more filters before entering the tank 194 to remove portions of the seed and/or seed treatment formulation residue from the fluid. Although the vacuum source 192 is described above as being activated after the pump 206 is deactivated, it should be appreciated that the vacuum source 192 may be operated concurrently with the pump 206. In other words, the vacuum source 192 may be activated when the pump 206 is activated or at some later time while the pump 206 is operating.

This cycle of fluid delivery to and retrieval from the mixing chamber 116 may be repeated with respect to the seed treatment device 102 and/or another seed treatment device. In other words, fluid in the tank 194 may be used in multiple cleaning cycles for the same seed treatment device 102 and/or multiple cleaning cycles for different seed treatment devices (including the seed treatment device 102). As such, fluid used to clean the mixing chamber 116 of the seed treatment device 102 (and/or a mixing chamber of another seed treatment device) may be recycled (e.g., recirculated, etc.) and reused, thereby reducing the amount of fluid used.

In some embodiments, the fluid delivery assembly 104 may be selectively coupled to the seed treatment device 102, for instance, when desired to clean the seed treatment device 102. In such embodiments, the cover plate 138 is configured to detachably couple to the lid 112 of the seed treatment device 102 at the opening 146 of the lid 112 (as described above). The system 100 may then be activated to clean the seed treatment device 102. Once cleaning operation is complete, the fluid delivery assembly may be removed from the lid 112 to allow subsequent operation of the seed treatment device 102 to coat and/or treat seeds. Alternatively, in some embodiments the fluid delivery assembly 104 may remain coupled to the seed treatment device 102, both in use for cleaning the seed treatment device 102 and when the seed treatment device 102 operates to coat and/or treat seeds. In such embodiments, the spray arm 152 and the recovery arm 166 are configured to selectively descend into the mixing chamber 116 for cleaning of the mixing chamber 116 (as described above) (e.g., via trolley 156 and/or another trolley, etc.) and then to retract out of the mixing chamber 116 after cleaning (so as not to impact seed coating and/or treating during subsequent operation of the seed treatment device 102).

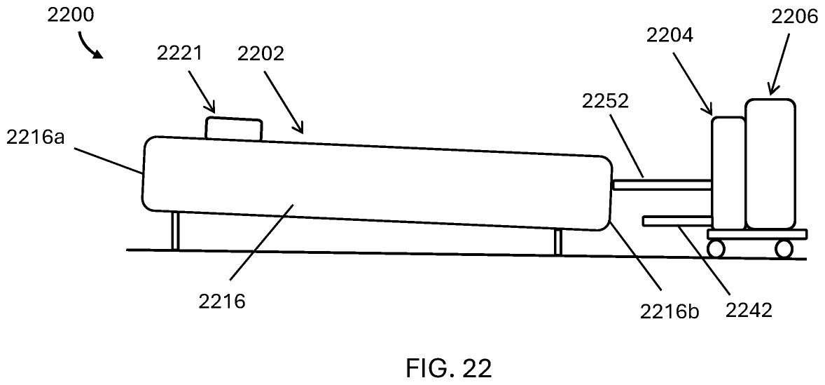

It should be appreciated that the fluid delivery systems herein and/or the fluid supply systems herein may have other configurations, arrangements, etc. than illustrated based on a type, configuration, etc. of seed treatment device with which the fluid supply assemblies and/or fluid supply systems are to be used (e.g., with a continuous batch seed treater, with a continuous flow seed treater, etc.). For instance, FIG. 22 schematically illustrates an example seed treatment system 2200, which generally includes a continuous flow seed treatment device 2202, a fluid delivery assembly 2204, and a fluid supply assembly 2206.

As shown in FIG. 22, the continuous flow seed treatment device 2202 includes a mixing chamber 2216 defining an inlet 2216a and an outlet 2216b. In operation, seeds flow into the mixing chamber 2216, via the inlet 2216a, for treatment (consistent with the description herein) and then exit the mixing chamber 2216, via the outlet 2216b, following such treatment. In connection therewith, the mixing chamber 2216 may be sloped generally downward from the inlet 2216a to the outlet 2216b to allow for the seeds to flow therebetween. Further, the mixing chamber 2216 includes a seed treatment applicator 2221 (e.g., similar to seed treatment application 121, etc.) with a portion that extends into the mixing chamber 2216. The seed treatment applicator 2221 may be configured to dispense seed treatment formulation into the mixing chamber 2216, for example, as the seeds flow through the mixing chamber 2216, as the seeds are rotated and/or agitated in the mixing chamber 2216, etc. The seed treatment applicator 2221 may be fluidly connected to a source of seed treatment formulation (not shown).

In this embodiment, the fluid delivery assembly 2204 generally includes a spray arm 2252 (similar to spray arm 152) configured to discharge cleaning fluid into the mixing chamber 2216 of the continuous flow seed treatment device 2202 for cleaning the mixing chamber 2216 of residual seed treatment and seeds, and a recovery assembly 2242 configured to remove the cleaning fluid from the mixing chamber 2216. In addition in this embodiment, the spray arm 2252 is arranged generally horizontally and is configured to movably extend into the outlet 2216a of the mixing chamber 2216 (e.g., via a trolly similar to trolly 156, etc.) (e.g., independent of and/or without use of a lid of the mixing chamber 2216, etc.), to discharge the cleaning fluid into the mixing chamber 2216 (in a similar manner to the spray arm 152 described above), and then moveably extend out of the mixing chamber 2216 as desired (e.g., again via the trolly, etc.). And, the recovery assembly 2242 then includes a recovery wand, etc. oriented generally horizontally and configured to extend into the outlet 2216b of the mixing chamber 2216 (e.g., independent of and/or without use of a lid of the mixing chamber 2216, etc.), to capture and remove the cleaning fluid from the mixing chamber 2216 (in a similar manner to the recovery wand 166 and recovery assembly 142 described above). For example, the recovery assembly 2242 (e.g., the recovery wand, etc.) may be positioned adjacent the outlet 2216b of the mixing chamber 2216 and, as the cleaning fluid flows along a bottom of the mixing chamber 2216 toward the outlet 2216b, the recovery assembly 2242 operates to collect the cleaning fluid and recycle the collected cleaning fluid as described above.

In some embodiments, the seed treatment formulation herein may include a seed treatment active, such as a biological agent and/or agrochemical. For example, the seed treatment formulation may include a seed-finishing agent suitable for enhancing one or more physical properties of the exterior surfaces of the seeds. The seed treatment formulations may be applied in a dry state or a wet state (e.g., slurry). After being contacted by the seed treatment active, for purposes herein, the seeds are referred to as treated seeds.

In some embodiments, the seed treatment active may include one or more pesticidal agents. Pesticidal agents may include chemical pesticides and biopesticides or biocontrol agents. Various types of chemical pesticides and biopesticides may include acaricides, insecticides, nematicides, fungicides, gastropodicides, herbicides, virucides, bactericides, and combinations thereof. Biopesticides or biocontrol agents may include bacteria, fungi, beneficial nematodes, and viruses that exhibit pesticidal activity.

Non-limiting examples of chemical acaricides, insecticides, and/or nematicides may include one or more carbamates, diamides, macrocyclic lactones, neonicotinoids, organophosphates, phenylpyrazoles, pyrethrins, spinosyns, synthetic pyrethroids, tetronic acids and/or tetramic acids. Non-limiting examples of chemical acaricides, insecticides and nematicides that can be useful in compositions of the present disclosure include abamectin, acrinathrin, aldicarb, aldoxycarb, alpha-cypermethrin, betacyfluthrin, bifenthrin, cyhalothrin, cypermethrin, deltamethrin, esfenvalerate, etofenprox, fenpropathrin, fenvalerate, flucythrinate, fosthiazate, lambda-cyhalothrin, gamma-cyhalothrin, permethrin, tau-fluvalinate, transfluthrin, zeta-cypermethrin, cyfluthrin, bifenthrin, tefluthrin, eflusilanat, fubfenprox, pyrethrin, resmethrin, imidacloprid, acetamiprid, thiamethoxam, nitenpyram, thiacloprid, dinotefuran, clothianidin, chlorfluazuron, diflubenzuron, lufenuron, teflubenzuron, triflumuron, novaluron, flufenoxuron, hexaflumuron, bistrifluoron, noviflumuron, buprofezin, cyromazine, methoxyfenozide, tebufenozide, halofenozide, chromafenozide, endosulfan, fipronil, ethiprole, pyrafluprole, pyriprole, flubendiamide, chlorantraniliprole (e.g., Rynaxypyr), cyazypyr, emamectin, emamectin benzoate, abamectin, ivermectin, milbemectin, lepimectin, tebufenpyrad, fenpyroximate, pyridaben, fenazaquin, pyrimidifen, tolfenpyrad, dicofol, cyenopyrafen, cyflumetofen, acequinocyl, fluacrypyrin, bifenazate, diafenthiuron, etoxazole, clofentezine, spinosad, triarathen, tetradifon, propargite, hexythiazox, bromopropylate, chinomethionat, amitraz, pyrifluquinazon, pymetrozine, flonicamid, pyriproxyfen, diofenolan, chlorfenapyr, metaflumizone, indoxacarb, chlorpyrifos, spirodiclofen, spiromesifen, spirotetramat, pyridalyl, spinctoram, acephate, triazophos, profenofos, oxamyl, spinetoram, fenamiphos, fenamipclothiahos, 4-{[(6-chloropyrid-3-yl) methyl](2,2-difluoroethyl)amino}furan-2(5H)-one, 3,5-disubstituted-1,2,4-oxadiazole compounds, 3-phenyl-5-(thien-2-yl)-1,2,4-oxadiazole, cadusaphos, carbaryl, carbofuran, ethoprophos, thiodicarb, aldicarb, aldoxycarb, metamidophos, methiocarb, sulfoxaflor, methamidophos, cyantraniliprole and tioxazofen and combinations thereof. Additional non-limiting examples of chemical acaricides, insecticides, and/or nematicides may include one or more of abamectin, aldicarb, aldoxycarb, bifenthrin, carbofuran, chlorantraniliporle, chlothianidin, cyfluthrin, cyhalothrin, cypermethrin, cyantraniliprole, dinotefuran, emamectin, ethiprole, fenamiphos, fipronil, flubendiamide, fosthiazate, imidacloprid, ivermectin, lambda-cyhalothrin, milbemectin, nitenpyram, oxamyl, permethrin, spinetoram, spinosad, spirodichlofen, spirotetramat, tefluthrin, thiacloprid, thiamethoxam, tioxazofen and/or thiodicarb, and combinations thereof.

Additional non-limiting examples of acaricides, insecticides and nematicides that may be included or used in seed treatment formulations in some embodiments may be found in Steffcy and Gray, Managing Insect Pests, ILLINOIS AGRONOMY HANDBOOK (2008); and Niblack, Nematodes, ILLINOIS AGRONOMY HANDBOOK (2008), the contents and disclosures of which are incorporated herein by reference. Non-limiting examples of commercial insecticides which may be suitable for the seed treatment formulations disclosed herein include CRUISER (Syngenta, Wilmington, Delaware), GAUCHO and PONCHO (Gustafson, Plano, Texas). Active ingredients in these and other commercial insecticides may include thiamethoxam, clothianidin, and imidacloprid. Commercial acaricides, insecticides, and/or nematicides may be used in accordance with a manufacturer's recommended amounts or concentrations.

In some embodiments, the seed treatment active may include one or more biopesticidal agents the presence and/or output of which is toxic to an acarid, insect and/or nematode. For example, the seed treatment active may include one or more of Bacillus firmus 1-1582, Bacillus mycoides AQ726, NRRL B-21664; Beauveria bassiana ATCC-74040, Beauveria bassiana ATCC-74250, Burkholderia sp. A396 sp. Nov. rinojensis, NRRL B-50319, Chromobacterium subtsugae NRRL B-30655, Chromobacterium vaccinii NRRL B-50880, Flavobacterium H492, NRRL B-50584, Metarhizium anisopliae F52 (also known as Metarhizium anisopliae strain 52, Metarhizium anisopliae strain 7, Metarhizium anisopliae strain 43, and/or Metarhizium anisopliae BIO-1020, TAE-001; deposited as DSM 3884, DSM 3885, ATCC 90448, SD 170 and ARSEF 7711), Paecilomyces fumosoroseus FE991, and combinations thereof.

Non-limiting examples of chemical fungicides may include one or more aromatic hydrocarbons, benzthiadiazole, carboxylic acid amides, morpholines, phenylamides, phosphonates, thiazolidines, thiophene, quinone outside inhibitors and strobilurins, such as azoxystrobin, coumethoxystrobin, coumoxystrobin, dimoxystrobin, enestroburin, fluoxastrobin, kresoxim-methyl, metominostrobin, orysastrobin, picoxystrobin, pyraclostrobin, pyrametostrobin, pyraoxystrobin, pyribencarb, trifloxystrobin, 2-[2-(2,5-dimethyl-phenoxymethyl)-phenyl]-3-methoxy-acrybc acid methyl ester, and 2-(2-(3-(2,6-dichlorophenyl)-1-methyl-allylidencaminooxymethyl)-phenyl)-2-methoxyimino-N-methyl-acetamide, carboxamides, such as carboxanilides (e.g., benalaxyl, benalaxyl-M, benodanil, bixafen, boscabd, carboxin, fenfuram, fenhexamid, flutolanil, fluxapyroxad, furametpyr, isopyrazam, isotianil, kiralaxyl, mepronil, metalaxyl, metalaxyl-M (mefenoxam), ofurace, oxadixyl, oxycarboxin, penflufen, penthiopyrad, sedaxane, tecloftalam, thifluzamide, tiadinil, 2-amino-4-methyl-thiazole-5-carboxanilide, N-(4′-trifluoromethylthiobiphenyl-2-yl)-3-difluoromethyl-1-methyl-1H-pyra-zole-4-carboxamide, N-(2-(1,3,3-trimethylbutyl)-phenyl)-1,3-dimethyl-5-fluoro-1H-pyrazole-4-carboxamide), carboxylic morpholides (e.g., dimethomorph, flumorph, pyrimorph), benzoic acid amides (e.g., flumetover, fluopicolide, fluopyram, zoxamide), carpropamid, dicyclomet, mandiproamid, fenchexamid, oxytetracyclin, silthiofam, andN-(6-methoxy-pyridin-3-yl) cyclopropanecarboxylic acid amide, spiroxamine, azoles, such as triazoles (e.g., azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole) and imidazoles (e.g., cyazofamid, imazalil, pefurazoate, prochloraz, triflumizol); heterocyclic compounds, such as pyridines (e.g., fluazinam, pyrifenox (cf.Dlb), 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine), pyrimidines (e.g., bupirimate, cyprodinil, diflumetorim, fenarimol, ferimzone, mepanipyrim, nitrapyrin, nuarimol, pyrimethanil), piperazines (e.g., triforinc), pyrroles (e.g., fenpiclonil, fludioxonil), morpholines (e.g., aldimorph, dodemorph, dodemorph-acetate, fenpropimorph, tridemorph), piperidines (e.g., fenpropidin); dicarboximides (e.g., fluoroimid, iprodione, procymidone, vinclozolin), non-aromatic 5-membered heterocycles (e.g., famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester), acibenzolar-S-methyl, ametoctradin, amisulbrom, anilazin, blasticidin-S, captafol, captan, chinomethionat, dazomet, debacarb, diclomezine, difenzoquat, difenzoquat-methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole and 5-chloro-7-(4-methylpiperidin-1 -yl)-6-(2,4,6-trifluorophenyl)-[1,2,4]triazolo-[1,5-a]pyrimidine; benzimidazoles, such as carbendazim; and other active substances, such as guanidines (e.g., guanidine, dodine, dodine free base, guazatine, guazatine-acetate, iminoctadine), iminoctadine-triacetate and iminoctadine-tris (albesilate); antibiotics (e.g., kasugamycin, kasugamycin hydrochloride-hydrate, streptomycin, polyoxine and validamycin A), nitrophenyl derivates (e.g., binapacryl, dicloran, dinobuton, dinocap, nitrothal-isopropyl, tecnazen). Organometal compounds (e.g., fentin salts, such as fentin-acetate, fentin chloride, fentin hydroxide); sulfur-containing heterocyclyl compounds (e.g., dithianon, isoprothiolanc), organophosphorus compounds (e.g., edifenphos, fosctyl, iprobenfos, phosphorus acid and its salts, pyrazophos, tolclofos-methyl), organochlorine compounds (e.g., chlorothalonil, dichlofluanid, dichlorophen, flusulfamide, hexachlorobenzene, pencycuron, pentachlorphenole and its salts, phthalide, quintozene, thiophanate-methyl, thiophanates, tolylfluanid, N-(4-chloro-2-nitro-phenyl)-N-ethyl-4-methyl-benzenesulfonamide) and inorganic active substances (e.g., Bordeaux mixture, copper acetate, copper hydroxide, copper oxychloride, basic copper sulfate, sulfur) and combinations thereof. In an aspect, the seed treatment active comprises comprise acibenzolar-S-methyl, azoxystrobin, benalaxyl, bixafen, boscabd, carbendazim, cyproconazole, dimethomorph, epoxiconazole, fludioxonil, fluopyram, fluoxastrobin, flutianil, flutolanil, fluxapyroxad, fosctyl-Al, ipconazole, isopyrazam, kresoxim-methyl, mefenoxam, metalaxyl, metconazole, myclobutanil, orysastrobin, penflufen, penthiopyrad, picoxystrobin, propiconazole, prothioconazole, pyraclostrobin, sedaxane, silthiofam, tebuconazole, thiabendazole, thifluzamide, thiophanate, tolclofos-methyl, trifloxystrobin and triticonazole, and combinations thereof.

Additional examples of fungicides that may be included in the seed treatment active formulations in some embodiments may be found, for example, in Bradley, Managing Diseases, ILLINOIS AGRONOMY HANDBOOK (2008), the content and disclosure of which are incorporated herein by reference. Fungicides useful for seed treatment formulations in some embodiments may include compounds that exhibit activity against one or more fungal plant pathogens, including but not limited to Phytophthora, Rhizoctonia, Fusarium, Pythium, Phomopsis, Sclerotinia or Phakopsora, and combinations thereof. Non-limiting examples of commercial fungicides which may be suitable for the seed treatment formulations in some embodiments include PROTÈGÈ, RIVAL or ALLEGIANCE FL or LS (Gustafson, Plano, Texas), WARDEN RTA (Agrilance, St. Paul, Minnesota), APRON XL, APRON MAXX RTA or RFC, MAXIM 4FS or XL (Syngenta, Wilmington, Delaware), CAPTAN (Arvesta, Guelph, Ontario) and PROTREAT (Nitragin Argentina, Buenos Ares, Argentina). Active ingredients in these and other commercial fungicides include, but are not limited to, fludioxonil, mefenoxam, azoxystrobin and metalaxyl. Commercial fungicides may be used in accordance with a manufacturer's recommended amounts or concentrations.

In some embodiments, the seed treatment active may include one or more biopesticidal agents the presence and/or output of which is toxic to at least one fungus and/or bacteria. For example, the seed treatment active may include one or more of Ampelomyces quisqualis AQ 10® (Intrachem Bio GmbH & Co. KG, Germany), Aspergillus flavus AFLA-GUARD® (Syngenta Crop Protection, Inc., CH), Aureobasidium pullulans BOTECTOR® (bio-ferm GmbH, Germany), Bacillus pumilus AQ717 (NRRL B-21662), Bacillus pumilus NRRL B-30087, Bacillus AQ175 (ATCC 55608), Bacillus AQ177 (ATCC 55609), Bacillus subtilis AQ713 (NRRL B-21661), Bacillus subtilis AQ743 (NRRL B-21665), Bacillus amyloliquefaciens FZB24, Bacillus amyloliquefaciens FZB42, Bacillus amyloliquefaciens NRRL B-50349, Bacillus subtilis ATCC 55078, Bacillus subtilis ATCC 55079, Bacillus thuringiensis AQ52 (NRRL B-21619), Candida oleophila 1-182 (e.g., ASPIRE® from Ecogen Inc., USA), Candida saitoana BIOCURE® (in mixture with lysozyme; BASF, USA) and BIOCOAT® (ArystaLife Science, Ltd., Cary, NC), Clonostachys rosea f. catenulata (also referred to as Gliocladium catenulatum) J1446 (PRESTOP®, Verdera, Finland), Coniothyrium minitans CONTANS® (Prophyta, Germany), Cryphonectria parasitica (CNICM, France), Cryptococcus albidus YIELD PLUS® (Anchor Bio-Technologies, South Africa), Fusarium oxysporum BIOFOX® (from S.I.A.P.A., Italy) and FUSACLEAN® (Natural Plant Protection, France), Metschnikowia fructicola SHEMER® (Agrogreen, Israel), Microdochium dimerum ANTIBOT® (Agrauxine, France), Muscodor albus NRRL 30547, Muscodor roseus NRRL 30548, Phlebiopsis gigantea ROTSOP® (Verdera, Finland), Pseudozyma flocculosa SPORODEX® (Plant Products Co. Ltd., Canada), Pythium oligandrum DV74 (POLYVERSUM®, Remeslo SSRO, Biopreparaty, Czech Rep.), Reynoutria sachlinensis (e.g., REGALIA® from Marrone BioInnovations, USA), Streptomyces NRRL B-30145, Streptomyces M1064, Streptomyces galbus NRRL 30232, Streptomyces lydicus WYEC 108 (ATCC 55445), Streptomyces violaceusniger YCED 9 (ATCC 55660; DE-THATCH-9®, DECOMP-9® and THATCH CONTROL®, Idaho Research Foundation, USA), Streptomyces WYE 53 (ATCC 55750; DE-THATCH-9®, DECOMP-9® and THATCH CONTROL®, Idaho Research Foundation, USA), Talaromyces flavus VI 17b (PROTUS®, Prophyta, Germany), Trichoderma asperellum SKT-1 (ECO-HOPE®, Kumiai Chemical Industry Co., Ltd., Japan), Trichoderma atroviride LC52 (SENTINEL®, Agrimm Technologies Ltd, NZ), Trichoderma harzianum T-22 (PLANTSHIELD®, der Firma BioWorks Inc., USA), Trichoderma harzianum TH-35 (ROOT PRO®, from Mycontrol Ltd., Israel), Trichoderma harzianum T-39 (TRICHODEX®, Mycontrol Ltd., Israel; TRICHODERMA 2000®, Makhteshim Ltd., Israel), Trichoderma harzianum ICC012 and Trichoderma viride TRICHOPEL (Agrimm Technologies Ltd, NZ), Trichoderma harzianum ICC012 and Trichoderma viride ICC080 (REMEDIER® WP, Isagro Ricerca, Italy), Trichoderma polysporum and Trichoderma harzianum (BINAB®, BINAB Bio-Innovation AB, Sweden), Trichoderma stromaticum TRICOVAB® (C.E.P.L.A.C., Brazil), Trichoderma virens GL-21 (SOILGARD®, Certis LLC, USA), and combinations thereof.

In some embodiments, the seed treatment active may include one or more suitable chemical herbicides. The herbicides may be a pre-emergent herbicide, a post-emergent herbicide, or a combination thereof. Non-limiting examples of chemical herbicides may include one or more acetyl CoA carboxylase (ACCase) inhibitors, acetolactate synthase (ALS) inhibitors, acetanilides, acetohydroxy acid synthase (AHAS) inhibitors, photosystem II inhibitors, photosystem I inhibitors, protoporphyrinogen oxidase (PPO or Protox) inhibitors, carotenoid biosynthesis inhibitors, enolpyruvylshikimate-3-phosphate (EPSP) synthase inhibitors, glutamine synthetase inhibitors, dihydropteroate synthetase inhibitors, mitosis inhibitors, 4-hydroxyphenyl-pyruvate-dioxygenase (4-HPPD) inhibitors, synthetic auxins, auxin herbicide salts, auxin transport inhibitors, nucleic acid inhibitors and/or one or more salts, esters, racemic mixtures and/or resolved isomers thereof. Non-limiting examples of chemical herbicides that can be useful in compositions of the present disclosure include 2,4-dichlorophenoxyacetic acid (2,4-D), 2,4,5-trichlorophenoxyacetic acid (2,4,5-T), ametryn, amicarbazonc, aminocyclopyrachlor, acetochlor, acifluorfen, alachlor, atrazine, azafenidin, bentazon, benzofenap, bifenox, bromacil, bromoxynil, butachlor, butafenacil, butroxydim, carfentrazone-ethyl, chlorimuron, chlorotoluro, clethodim, clodinafop, clomazone, cyanazine, cycloxydim, cyhalofop, desmedipham, desmetryn, dicamba, diclofop, dimefuron, diflufenican, diuron, dithiopyr, cthofumesate, fenoxaprop, foramsulfuron, fluazifop, fluazifop-P, flufenacet, fluometuron, flufenpyr-cthyl, flumiclorac, flumiclorac-pentyl, flumioxazin, fluoroglycofen, fluthiacet-methyl, fomesafen, glyphosate, glufosinate, halosulfuron, haloxyfop, hexazinone, iodosulfuron, indaziflam, imazamox, imazaquin, imazcthapyr, ioxynil, isoproturon, isoxaflutole, lactofen, linuron, mecoprop, mecoprop-P, mesosulfuron, mesotrion, metamitron, metazochlor, methibenzuron, metolachlor (and S-metolachlor), metoxuron, metribuzin, monolinuron, oxadiargyl, oxadiazon, oxaziclomefone, oxyfluorfen, phenmedipham, pretilachlor, profoxydim, prometon, prometm, propachlor, propanil, propaquizafop, propisochlor, propoxycarbazone, pyraflufen-cthyl, pyrazon, pyrazolynate, pyrazoxyfen, pyridate, quizalofop, quizalofop-P (e.g., quizalofop-ethyl, quizalofop-P-cthyl, clodinafop-propargyl, cyhalofop-butyl, diclofop-methyl, fenoxaprop-P-cthyl, fluazifop-P-butyl, haloxyfop-methyl, haloxyfop-R-methyl), saflufenacil, sethoxydim, siduron, simazine, simetryn, sulcotrione, sulfentrazone, tebuthiuron, tembotrione, tepraloxydim, terbacil, terbumeton, terbuthylazine, thaxtomin (e.g., the thaxtomins described in U.S. Pat. No. 7,989,393), thiencarbazone-methyl, thenylchlor, tralkoxydim, triclopyr, trictazinc, trifloxysulfuron, tropramezone, salts and esters thereof; racemic mixtures and resolved isomers thereof and combinations thereof. In an embodiment, seed treatment active compositions comprise acetochlor, clethodim, dicamba, flumioxazin, fomesafen, glyphosate, glufosinate, mesotrione, quizalofop, saflufenacil, sulcotrione, S-3100 and/or 2,4-D, and combinations thereof.

Additional examples of herbicides that may be included in seed treatment formulations in some embodiments may be found in Hager, Weed Management, Illinois Agronomy Handbook (2008); and Loux et al., Weed Control Guide for Ohio, Indiana and Illinois (2015), the contents and disclosures of which are incorporated herein by reference. Commercial herbicides may be used in accordance with a manufacturer's recommended amounts or concentrations.

In various embodiments, the seed treatment active may include one or more biopesticidal agents the presence and/or output of which is toxic to at least one plant, including for example, weeds. Examples of biopesticides that may be included or used in compositions in some embodiments may be found in BURGES, supra; HALL & MENN, BIOPESTICIDES: USE AND DELIVERY (Humana Press) (1998); McCoy et al., Entomogenous fungi, in CRC HANBOOK OF NATURAL PESTICIDES. MICROBIAL PESTICIDES, PART A. ENTOMOGENOUS PROTOZOA AND FUNGI (C. M. Inoffo, ed.), Vol. 5:151-236 (1988); SAMSON et al., ATLAS OF ENTOMOPATHOGENIC FUNGI (Springer-Verlag, Berlin) (1988); and deFaria and Wraight, Mycoinsecticides and Mycoacaricides: A comprehensive list with worldwide coverage and international classification of formulation types, BIOL. CONTROL (2007), the contents and disclosures of which are incorporated herein by reference.

In some embodiments, the seed treatment active may include one or more additional agent. For example, the seed treatment active may include one or more beneficial biostimulants and/or microbial inoculants. Biostimulants or inoculants may enhance ion uptake, nutrient uptake, nutrient availability or delivery, or a combination thereof. Non limiting examples of biostimulants or inoculants that may be included or used in compositions may include bacterial extracts (e.g., extracts of one or more diazotrophs, phosphate-solubilizing microorganisms and/or biopesticides), fungal extracts, humic acids (e.g., potassium humate), fulvic acids, myo-inositol, and/or glycine, and any combinations thereof. According to some embodiments, the biostimulants or inoculants may comprise one or more Azospirillum (e.g., an extract of media comprising A. brasilense INTA Az-39), one or more Bradyrhizobium (e.g., an extract of media comprising B. elkanii SEMIA 501, B. elkanii SEMIA 587, B. elkanii SEMIA 5019, B. japonicum NRRL B-50586 (also deposited as NRRL B-59565), B. japonicum NRRL B-50587 (also deposited as NRRL B-59566), Bacillus amyloliquefaciens TJ 1000 (also known as 1BE, isolate ATCC BAA-390), B. japonicum NRRL B-50588 (also deposited as NRRL B-59567), B. japonicum NRRL B-50589 (also deposited as NRRL B-59568), B. japonicum NRRL B-50590 (also deposited as NRRL B-59569), B. japonicum NRRL B-50591 (also deposited as NRRL B-59570), Trichoderma virens G1-3 (ATCC 57678), Trichoderma virens Gl-21 (Thermo Trilogy Corporation, Wasco, CA), Trichoderma virens G1-3 and Bacillus amyloliquefaciens LZB24, Trichoderma virens G1-3 and Bacillus amyloliquefaciens NRRL B-50349, Trichoderma virens G1-3 and Bacillus amyloliquefaciens TJ1000, Trichoderma virens Gl-21 and Bacillus amyloliquefaciens LZB24, Trichoderma virens Gl-21 and Bacillus amyloliquefaciens NRRL B-50349, Trichoderma virens Gl-21 and Bacillus amyloliquefaciens TJ1000, Trichoderma viride TRIECO® (Ecosense Labs. (India) Pvt. Ltd., India, BIO-CURE® L from T. Stanes & Co. Ltd., Indien), Trichoderma viride TV1 (Agribiotec srl, Italy), Trichoderma viride ICC080, and/or Ulocladium oudemansii HRU3 (BOTRY-ZEN®, Botry-Zen Ltd, NZ), B. japonicum NRRL B-50592 (also deposited as NRRL B-59571), B. japonicum NRRL B-50593 (also deposited as NRRL B-59572), B. japonicum NRRL B-50594 (also deposited as NRRL B-50493), B. japonicum NRRL B-50608, B. japonicum NRRL B-50609, B. japonicum NRRL B-50610, B. japonicum NRRL B-50611, B. japonicum NRRL B-50612, B. japonicum NRRL B-50726, B. japonicum NRRL B-50727, B. japonicum NRRL B-50728, B. japonicum NRRL B-50729, B. japonicum NRRL B-50730, B. japonicum SEMIA 566, B. japonicum SEMIA 5079, B. japonicum SEMIA 5080, B. japonicum USDA 6, B. japonicum USDA 110, B. japonicum USDA 122, B. japonicum USDA 123, B. japonicum USDA 127, B. japonicum USDA 129 and/or B. japonicum USDA 532C), one or more Rhizobium extracts (e.g., an extract of media comprising R. leguminosarum S012A-2), one or more Sinorhizobium extracts (e.g., an extract of media comprising S. fredii CCBAU114 and/or S. fredii USDA 205), one or more Penicillium extracts (e.g., an extract of media comprising P. bilaiae ATCC 18309, P. bilaiae ATCC 20851, P. bilaiae ATCC 22348, P. bilaiaeNRRL 50162, P. bilaiae NRRL 50169, P. bilaiae NRRL 50776, P. bilaiae NRRL 50777, P. bilaiae NRRL 50778, P. bilaiae NRRL 50777, P. bilaiae NRRL 50778, P. bilaiae NRRL 50779, P. bilaiae NRRL 50780, P. bilaiae NRRL 50781, P. bilaiae NRRL 50782, P. bilaiae NRRL 50783, P. bilaiae NRRL 50784, P. bilaiae NRRL 50785, P. bilaiae NRRL 50786, P. bilaiae NRRL 50787, P. bilaiae NRRL 50788, P. bilaiae RS7B-SD1, P. brevicompactum AgRF18, P. canescens ATCC 10419, P. expansum ATCC 24692, P. expansum YT02, P. fellatanum ATCC 48694, P. gaestrivorus NRRL 50170, P. glabrum DAOM 239074, P. glabrum CBS 229.28, P. janthinellum ATCC 10455, P. lanosocoeruleum ATCC 48919, P. radicum ATCC 201836, P. radicum FRR 4717, P. radicumFRR 4719, P. radicum N93/47267 and/or P. raistrickii ATCC 10490), one or more Pseudomonas extracts (e.g., an extract of media comprising P. jessenii PS06), one or more acaricidal, insecticidal and/or nematicidal extracts (e.g., an extract of media comprising Bacillus firmus 1-1582, Bacillus mycoides AQ726, NRRL B-21664; Beauveria bassiana ATCC-74040, Beauveria bassiana ATCC-74250, Burkholderia sp. A396 sp. Nov. rinojensis, NRRL B-50319, Chromobacterium subtsugae NRRL B-30655, Chromobacterium vaccinii NRRL B-50880, Flavobacterium H492, NRRL B-50584, Metarhizium anisopliae F52 (also known as Metarhizium anisopliae strain 52, Metarhizium anisopliae strain 7, Metarhizium anisopliae strain 43 and Metarhizium anisopliae BIO-1020, TAE-001; deposited as DSM 3884, DSM 3885, ATCC 90448, SD 170 and ARSEF 7711) and/or Paecilomyces fumosoroseus FE991), and/or one or more fungicidal extracts (e.g., an extract of media comprising Ampelomyces quisqualis AQ 10® (Intrachem Bio GmbH & Co. KG, Germany), Aspergillus flavus AFLA-GUARD® (Syngenta Crop Protection, Inc., CH), Aureobasidium pullulans BOTECTOR® (bio-ferm GmbH, Germany), Bacillus pumilus AQ717 (NRRL B-21662), Bacillus pumilus NRRL B-30087, BacillusAQ175 (ATCC 55608), Bacillus AQ177 (ATCC 55609), Bacillus subtilis AQ713 (NRRL B-21661), Bacillus subtilis AQ743 (NRRL B-21665), Bacillus amyloliquefaciens FZB24, Bacillus amyloliquefaciens NRRL B-50349, Bacillus amyloliquefaciens TJ1000 (also known as IBE, isolate ATCC BAA-390), Bacillus thuringiensis AQ52 (NRRL B-21619), Candida oleophila 1-82 (e.g., ASPIRE® from Ecogen Inc., USA), Candida saitoana BIOCURE® (in mixture with lysozyme; BASF, USA) and BIOCOAT® (ArystaLife Science, Ltd., Cary, NC), Clonostachys rosea f. catenulata (also referred to as Gliocladium catenulatum) J1446 (PRESTOP®, Verdera, Finland), Coniothyrium minitans CONTANS® (Prophyta, Germany), Cryphonectria parasitica (CNICM, France), Cryptococcus albidus YIELD PLUS® (Anchor Bio-Technologies, South Africa), Fusarium oxysporum BIOFOX® (from S.I.A.P.A., Italy) and FUSACLEAN® (Natural Plant Protection, France), Metschnikowia fructicola SHEMER® (Agrogreen, Israel), Microdochium dimerum ANHBOT® (Agrauxine, France), Muscodor albus NRRL 30547, Muscodor roseus NRRL 30548, Phlebiopsis gigantea ROTSOP® (Verdera, Finland), Pseudozyma flocculosa SPORODEX® (Plant Products Co. Ltd., Canada), Pythium oligandrum DV74 (POLYVERSUM®, Remeslo SSRO, Biopreparaty, Czech Rep.), Reynoutria sachlinensis (e.g., REGALIA® from Marrone BioInnovations, USA), Streptomyces NRRL B-30145, Streptomyces M1064, Streptomyces galbus NRRL 30232, Streptomyces lydicus WYEC 108 (ATCC 55445), Streptomyces violaceusniger YCED 9 (ATCC 55660; DE-THATCH-9®, DECOMP-9® and THATCH CONTROL®, Idaho Research Foundation, USA), Streptomyces WYE 53 (ATCC 55750; DE-THATCH-9®, DECOMP-9® and THATCH CONTROL®, Idaho Research Foundation, USA), Talaromyces flavus Y 117b (PROTUS®, Prophyta, Germany), Trichoderma asperellum SKT-1 (ECO-HOPE®, Kumiai Chemical Industry Co., Ltd., Japan), Trichoderma atroviride LC52 (SENTINEL®, Agrimm Technologies Ltd, NZ), Trichoderma harzianum T-22 (PLANTSHIELD®, der Firma BioWorks Inc., USA), Trichoderma harzianum TH-35 (ROOT PRO®, from Mycontrol Ltd., Israel), Trichoderma harzianum T-39 (TRICHODEX®), Mycontrol Ltd., Israel; TRICHODERMA 2000®, Makhteshim Ltd., Israel), Trichoderma harzianum ICC012 and Trichoderma viride TRICHOPEL (Agrimm Technologies Ltd, NZ), Trichoderma harzianum ICC012 and Trichoderma viride ICC080 (REMEDIER® WP, Isagro Ricerca, Italy), Trichoderma polysporum and Trichoderma harzianum (BINAB®, BINAB Bio-Innovation AB, Sweden), Trichoderma stromaticum TRICOVAB® (C.E.P.L.A.C., Brazil), Trichoderma virens GL-21 (SOILGARD®, Certis LLC, USA), Trichoderma virens G1-3, ATCC 57678, Trichoderma virens Gl-21 (Thermo Trilogy Corporation, Wasco, CA), Trichoderma virens G1-3 and Bacillus amyloliquefaciens FZB2, Trichoderma virens G1-3 and Bacillus amyloliquefaciens NRRL B-50349, Trichoderma virens G1-3 and Bacillus amyloliquefaciens TJ1000, Trichoderma virens G1-21 and Bacillus amyloliquefaciens FZB24, Trichoderma virens G1-21 and Bacillus amyloliquefaciens NRRL B-50349, Trichoderma virens Gl-21 and Bacillus amyloliquefaciens TJ1000, Trichoderma viride TRIECO® (Ecosense Labs. (India) Pvt. Ltd., Indien, BIO-CURE® F from T. Stanes & Co. Ltd., Indien), Trichoderma viride TVI (Agribiotec srl, Italy), Trichoderma viride ICC080, and/or Ulocladium oudemansii HRU3 (BOTRY-ZEN®, Botry-Zen Ltd, NZ)), and combinations thereof.

In some embodiments, the seed treatment active may include one or more beneficial microbes. Non-limiting examples of such microbes include beneficial microbes selected from the following genera: Actinomycetes, Agrobacterium, Arthrobacter, Alcaligenes, Acinetobacter spp., Azospirillum spp., Aureobacterium, Azobacter, Azorhizobium, Bacillus, Beijerinckia, Bradyrhizobium, Brevibacillus, Burkholderia, Chromobacterium, Chryseomona sspp., Clostridium, Clavibacter, Comamonas, Corynebacterium, Curtobacterium, Enterobacter, Eupenicillium spp., Exiguobacterium spp., Flavobacterium, Gluconobacter, Hydrogenophaga, Hymenoscyphous, Klebsiella, Kluyvera spp., Methylobacterium, Paenibacillus, Pasteuria, Photorhabdus, Phyllobacterium, Pseudomonas, Rhizobium, Rhizobacter, Rhizopogon, Serratia, Sinorhizobium, Sphingobacterium, Swaminathania spp., Stenotrophomonas, Streptomyces spp., Thiobacillus, Variovorax, Vibrio, Xanthobacter, Xanthomonas and Xenorhabdus, or any combination thereof. According to some embodiments, the seed treatment active comprises one or more of Bacillus amyloliquefaciens, Bacillus cereus, Bacillus firmus, Bacillus, lichenformis, Bacillus pumilus, Bacillus sphaericus, Bacillus subtilis, Bacillus thuringiensis, Chromobacterium subtsugae, Pasteuria penetrans, Pasteuria usage, and Pseudomona fluorescens. According to some embodiments, a microbe may comprise a fungus of the genus Alternaria, Ampelomyces, Arthrobotrys spp., Aspergillus, Aureobasidium, Beauveria, Candid aspp., Colletotrichum, Coniothyrium, Gigaspora spp,. Gliocladium, Glomus spp., Laccaria spp., Metarhizium, Mucor spp., Muscodor, Oidiodendron spp., Paecilomyces, Penicillium spp., Pisolithus spp., Scleroderma, Trichoderma, Typhula, Ulocladium, and Verticillium. In another aspect, a fungus is Beauveria bassiana, Coniothyrium minitans, Gliocladium virens, Muscodor albus, Paecilomyces lilacinus, or Trichoderma polysporum.

In some embodiments, the seed treatment active may include one or more lipo-chitooligosaccharides (LCOs), chitin oligomer(s) and/or chitosan oligomer(s) (collectively referred to hereinafter as Cos), and/or chitinous compounds. LCOs, sometimes referred to as symbiotic nodulation (Nod) signals (or Nod factors) or as Myc factors, consist of an oligosaccharide backbone of β-1, 4-linked N-acetyl-D-glucosaminc (“GlcNAc”) residues with an N-linked fatty acyl chain condensed at the non-reducing end. As understood in the art, LCOs differ in the number of GlcNAc residues in the backbone, in the length and degree of saturation of the fatty acyl chain and in the substitutions of reducing and non-reducing sugar residues. Sec, e.g., Denaric et al, Ann. Rev. Biochem. 65:503 (1996); Diaz et al, Mol. Plant-Microbe Interactions 13:268 (2000); Hungria et al, Soil Biol. Biochem. 29:819 (1997); Hamel et al, Planta 232:787 (2010); and Prome et al, Pure & Appl. Chem. 70 (1): 55 (1998), the contents and disclosures of which are incorporated herein by reference.

LCOs may be synthetic or obtained from any suitable source. Sec, e.g., WO 2005/063784, WO 2007/117500 and WO 2008/071674, the contents and disclosures of which are incorporated herein by reference. In some aspects, a synthetic LCO may have the basic structure of a naturally occurring LCO but contains one or more modifications or substitutions, such as those described in Spaink, Crit. Rev. Plant Sci. 54:257 (2000). LCOs and precursors for the construction of LCOs (e.g., Cos, which may themselves be useful as a biologically active ingredient) can be synthesized by genetically engineered organisms. Sec, e.g., Samain et al., Carbohydrate Res. 302:35 (1997); Cottaz et al., Meth. Eng. 7 (4): 311 (2005); and Samain et al., J. Biotechnol. 72:33 (1999) (e.g., FIG. 1 therein, which shows structures of Cos that can be made recombinantly in E. coli harboring different combinations of genes nodBCHL), the contents and disclosures of which are incorporated herein by reference.

LCOs (and derivatives thereof) may be included or utilized in compositions in various forms of purity and can be used alone or in the form of a culture of LCO-producing bacteria or fungi. For example, OPTIMIZE® (commercially available from Monsanto Company (St. Louis, MO)) contains a culture of Bradyrhizobium japonicum that produces LCO. Methods to provide substantially pure LCOs include removing the microbial cells from a mixture of LCOs and the microbe, or continuing to isolate and purify the LCO molecules through LCO solvent phase separation followed by HPLC chromatography as described, for example, in U.S. Pat. No. 5,549,718. Purification can be enhanced by repeated HPLC and the purified LCO molecules can be freeze-dried for long-term storage. According to some embodiments, the LCO(s) included in compositions of the present disclosure is/are at least 0.1%, 0.5%, 1%, 2%, 3%, 4%, 5%, 10%, 15%, 20%, 25%, 30%, 35%, 40%, 45%, 50%, 55%, 60%, 65%, 70%, 75%, 80%, 85%, 90%, 91%, 92%, 93%, 94%, 95%, 96%, 97%, 98%, 99% or 100% pure. Compositions and methods in some embodiments may comprise analogues, derivatives, hydrates, isomers, salts and/or solvates of LCOs. LCOs may be incorporated into compositions of the present disclosure in any suitable amount(s)/concentration(s). For example, compositions of the present disclosure comprise about 1×10⁻²⁰ M to about 1×10⁻¹ M LCO(s). For example, compositions of the present disclosure can comprise about 1×10⁻²⁰ M, 1×10⁻¹⁹ M, 1×10⁻¹⁸ M, 1×10⁻¹⁷ M, 1×10⁻¹⁶ M, 1×10⁻¹⁵ M, 1×10⁻¹⁴ M, 1×10⁻¹³ M, 1×10⁻¹² M, 1×10⁻¹¹ M, 1×10⁻¹⁰ M, 1×10⁻⁹ M, 1×10⁻⁸ M, 1×10⁻⁷ M, 1×10⁻⁶ M, 1×10⁻⁵ M, 1×10⁻⁴ M, 1×10⁻³ M, 1×10⁻² M, or 1×10⁻¹ M of one or more LCOs. In an aspect, the LCO concentration is 1×10⁻¹⁴ M to 1×10⁻⁵ M, 1×10⁻¹² M to 1×10⁻⁶ M, or 1×10⁻¹⁰ M to 1×10⁻⁷ M. The amount/concentration of LCO may be an amount effective to impart a positive trait or benefit to a plant, such as to enhance the disease resistance, growth and/or yield of the plant to which the composition is applied. According to some embodiments, the LCO amount/concentration is not effective to enhance the yield of the plant without beneficial contributions from one or more other constituents of the composition, such as CO and/or one or more pesticides.

In some embodiments, the seed treatment active may include one or more chitin oligomers and/or chitosan oligomers. Sec, e.g., D'Haeze et al., Glycobiol. 12 (6): 79R (2002); Demont-Caulet et al., Plant Physiol. 120 (1): 83 (1999): Hanel et al. Planta 232:787 (2010); Muller et al., Plant Physiol. 124:733 (2000); Robina et al., Tetrahedron 58:521-530 (2002); Rouge et al., Docking of Chitin Oligomers and Nod Factors on Lectin Domains of the LysM-RLK Receptors in the Medicago-Rhizobium Symbiosis, in The Molecular Immunology of Complex Carbohydrates-3 (Springer Science, 2011); Van der Holst et al., Curr. Opin. Struc. Biol. 11:608 (2001); and Wan et al., Plant Cell 21:1053 (2009), the contents and disclosures of which are incorporated by reference. Cos may be obtained from any suitable source. For example, Cos may be derived from an LCO. For example, in an aspect, compositions comprise one or more Cos derived from an LCO obtained (i.e., isolated and/or purified) from a strain of Azorhizohium, Bradyrhizohium (e.g., B. japonicum), Mesorhizobium, Rhizobium (e.g., R. leguminosarum), Sinorhizobium (e.g., S. meliloti), or mycorhizzal fungi (e.g., Glomus intraradicus). Alternatively, the CO may be synthetic. Methods for the preparation of recombinant Cos are known in the art. Sec, e.g., Cottaz et al., Meth. Eng. 7 (4): 311 (2005); Samain et al., Carbohydrate Res. 302:35 (1997); and Samain et al., J. Biotechnol. 72:33 (1999), the contents and disclosures of which are incorporated herein by reference.

Cos (and derivatives thereof) may be included or utilized in compositions in various forms of purity and can be used alone or in the form of a culture of CO-producing bacteria or fungi. According to some embodiments, the CO(s) included in compositions may be at least 0.1%, 0.5%, 1%, 2%, 3%, 4%, 5%, 6%, 7%, 8%, 9%, 10%, 15%, 20%, 30%, 40%, 50%, 60%, 70%, 75%, 80%, 85%, 90%, 91%, 92%, 93%, 94%, 95%, 96%, 97%, 98%, 99%, 99.5% or more pure. It is to be understood that compositions and methods of the present disclosure can comprise hydrates, isomers, salts and/or solvates of Cos. Cos in some embodiments may be incorporated into compositions in any suitable amount(s)/concentration(s). For example, compositions in some embodiments may comprise about 1×10⁻²⁰ M to about 1×10⁻¹ M Cos, such as about 1×10⁻²⁰ M, 1×10⁻¹⁹ M, 1×10⁻¹⁸ M, 1×10⁻¹⁷ M, 1×10⁻¹⁶ M, 1×10⁻¹⁵ M, 1×10⁻¹⁴ M, 1×10⁻¹³ M, 1×10⁻¹² M, 1×10⁻¹¹ M, 1×10⁻¹⁰ M, 1×10⁻⁹ M, 1×10⁻⁸ M, 1×10⁻⁷ M, 1×10⁻⁶ M, 1×10⁻⁵ M, 1×10⁻⁴ M, 1×10⁻³ M, 1×10⁻² M, or 1×10⁻¹ M of one or more Cos. For example, the CO concentration may be 1×10⁻¹⁴ M to 1×10⁻⁵ M, 1×10⁻¹² M to 1×10⁻⁶ M, or 1×10⁻¹⁰ M to 1×10⁻⁷ M. The amount/concentration of CO may be an amount effective to impart or confer a positive trait or benefit to a plant, such as to enhance the soil microbial environment, nutrient uptake, or increase the growth and/or yield of the plant to which the composition is applied. Compositions in some embodiments may comprise one or more suitable chitinous compounds, such as, for example, chitin (IUPAC: N-[5-[[3-acetylamino-4,5-dihydroxy-6-(hydroxymethyl) oxan-2yl]methoxymethyl]-2-[[5-acetylamino-4,6-dihydroxy-2-(hydroxymethyl) oxan-3-yI]methoxymethyl]-4-hydroxy-6-(hydroxymethyl)oxan-3-yl]ethanamide), chitosan (IUPAC: 5-amino-6-[5-amino-6-[5-amino-4,6-dihydroxy-2 (hydroxymethyl) oxan-3-yl]oxy-4-hydroxy-2-(hydroxymethyl) oxan-3-yl]oxy-2 (hydroxymethyl) oxane-3,4-diol), and isomers, salts and solvates thereof.

Chitins and chitosans, which are major components of the cell walls of fungi and the exoskeletons of insects and crustaceans, are composed of GlcNAc residues. Chitins and chitosans may be obtained commercially or prepared from insects, crustacean shells, or fungal cell walls. Methods for the preparation of chitin and chitosan are known in the art. See, e.g., U.S. Pat. No. 4,536,207 (preparation from crustacean shells) and U.S. Pat. No. 5,965,545 (preparation from crab shells and hydrolysis of commercial chitosan); and Pochanavanich et al., Lett. Appl. Microbiol. 35:17 (2002) (preparation from fungal cell walls).

Deacetylated chitins and chitosans may be obtained that range from less than 35% to greater than 90% deacetylation and cover a broad spectrum of molecular weights, e.g., low molecular weight chitosan oligomers of less than 15 kD and chitin oligomers of 0.5 to 2 kD; “practical grade” chitosan with a molecular weight of about 15 kD; and high molecular weight chitosan of up to 70 kD. Chitin and chitosan compositions formulationted for seed treatment are commercially available. Commercial products include, for example, ELEXA® (Plant Defense Boosters, Inc.) and BEYOND™ (Agrihouse, Inc.).

In some embodiments, the seed treatment active may comprise one or more suitable flavonoids, including, but not limited to, anthocyanidins, anthoxanthins, chalcones, coumarins, flavanones, flavanonols, flavans and isoflavonoids, as well as analogues, derivatives, hydrates, isomers, polymers, salts and solvates thereof. Flavonoids are phenolic compounds having the general structure of two aromatic rings connected by a three-carbon bridge. Classes of flavonoids are known in the art. See, e.g., Jain et al., J. Plant Biochem. & Biotechnol. 11:1 (2002); and Shaw et al., Environ. Microbiol. 11:1867 (2006), the contents and disclosures of which are incorporated herein by reference. Several flavonoid compounds are commercially available. Flavonoid compounds may be isolated from plants or seeds, e.g., as described in U.S. Pat. Nos. 5,702,752; 5,990,291; and 6,146,668. Flavonoid compounds may also be produced by genetically engineered organisms, such as yeast, See, e.g., Ralston et al., Plant Physiol. 137:1375 (2005).

The seed treatment active may include one or more flavanones, such as one or more of butin, eriodictyol, hesperetin, hesperidin, homoeriodictyol, isosakuranetin, naringenin, naringin, pinocembrin, poncirin, sakuranetin, sakuranin, and/or sterubin, one or more flavanonols, such as dihydrokaempferol and/or taxifolin, one or more flavans, such as one or more flavan-3-ols (e.g., catechin (C), catechin 3-gallate (Cg), epicatechins (EC), epigallocatechin (EGC) epicatechin 3-gallate (Ecg), epigallcatechin 3-gallate (EGCg), epiafzelechin, fisetinidol, gallocatechin (GC), gallcatechin 3-gallate (GCg), guibourtinidol, mesquitol, robinetinidol, theaflavin-3-gallate, theaflavin-3′-gallate, theflavin-3,3′-digallate, thearubigin), flavan-4-ols (e.g., apiforol and/or luteoforol) and/or flavan-3,4-diols (e.g., leucocyanidin, leucodelphinidin, leucofisetinidin, leucomalvidin, luecopelargonidin, leucopconidin, leucorobinetinidin, melacacidin and/or teracacidin) and/or dimers, trimers, oligomers and/or polymers thereof (e.g., one or more proanthocyanidins), one or more isoflavonoids, such as one or more isoflavones or flavonoid derivatives (e.g., biochanin A, daidzein, formononetin, genistein and/or glycitein), isoflavanes (e.g., equol, ionchocarpane and/or laxifloorane), isoflavandiols, isoflavenes (e.g., glabrene, haginin D and/or 2-methoxyjudaicin), coumestans (e.g., coumestrol, plicadin and/or wedelolactone), pterocarpans, roctonoids, neoflavonoids (e.g., calophyllolide, coutarcagenin, dalbergichromene, dalbergin, nivetin), and/or pterocarpans (e.g., bitucarpin A, bitucarpin B, crybracdin A, crybraedin B, erythrabyssin II, erthyrabissin-1, crycristagallin, glycinol, glyccollidins, glyccollins, glycyrrhizol, maackiain, medicarpin, morisianine, orientanol, phascolin, pisatin, striatine, trifolirhizin), and combinations thereof. Flavonoids and their derivatives may be included in compositions in any suitable form, including, but not limited to, polymorphic and crystalline forms. Flavonoids may be included in compositions in any suitable amount(s) or concentration(s). The amount/concentration of a flavonoid(s) may be an amount effective, which may be indirectly through activity on soil microorganisms or other means, such as to enhance plant nutrition and/or yield. According to some embodiments, a flavonoid amount/concentration may not be effective to enhance the nutrition or yield of the plant without the beneficial contributions from one or more other ingredients of the composition, such as LCO, CO, and/or one or more pesticides.

In some embodiments, the seed treatment active may comprise one or more non-flavonoid nod-gene inducer(s), including, but not limited to, jasmonic acid ([1II-[1a,2b (Z)]]-3-oxo-2-(pentenyl) cyclopentaneacetic acid; JA), linoleic acid ((Z,Z)-9,12-Octadecadienoic acid) and/or linolenic acid ((Z,Z,Z)-9,12,15-octadecatrienoic acid), and analogues, derivatives, hydrates, isomers, polymers, salts and solvates thereof. Jasmonic acid and its methyl ester, methyl jasmonate (MeJA), collectively known as jasmonates, are octadecanoid-based compounds that occur naturally in some plants (e.g., wheat), fungi (e.g., Botryodiplodia theobromae, Gibbrella fujikuroi), yeast (e.g., Saccharomyces cerevisiae) and bacteria (e.g., Escherichia coli). Linoleic acid and linolenic acid may be produced in the course of the biosynthesis of jasmonic acid.

Derivatives of jasmonic acid, linoleic acid, and linolenic acid that may be included or used in compositions in some embodiments include esters, amides, glycosides and salts thereof. Representative esters are compounds in which the carboxyl group of linoleic acid, linolenic acid, or jasmonic acid has been replaced with a —COR group, where R is an —OR¹ group, in which R¹ is: an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Representative amides are compounds in which the carboxyl group of linoleic acid, linolenic acid, or jasmonic acid has been replaced with a —COR group, where R is an NR²R³ group, in which R² and R³ are cach independently: a hydrogen; an alkyl group, such as a C₁-C₈ unbranched or branched alkyl group, e.g., a methyl, ethyl or propyl group; an alkenyl group, such as a C₂-C₈ unbranched or branched alkenyl group; an alkynyl group, such as a C₂-C₈ unbranched or branched alkynyl group; an aryl group having, for example, 6 to 10 carbon atoms; or a heteroaryl group having, for example, 4 to 9 carbon atoms, wherein the heteroatoms in the heteroaryl group can be, for example, N, O, P, or S. Esters may be prepared by known methods, such as acid-catalyzed nucleophilic addition, wherein the carboxylic acid is reacted with an alcohol in the presence of a catalytic amount of a mineral acid. Amides may also be prepared by known methods, such as by reacting the carboxylic acid with the appropriate amine in the presence of a coupling agent, such as dicyclohexyl carbodiimide (DCC), under neutral conditions. Suitable salts of linoleic acid, linolenic acid and jasmonic acid include, for example, base addition salts. The bases that may be used as reagents to prepare metabolically acceptable base salts of these compounds include those derived from cations such as alkali metal cations (e.g., potassium and sodium) and alkaline earth metal cations (e.g., calcium and magnesium). These salts may be readily prepared by mixing a solution of linoleic acid, linolenic acid, or jasmonic acid with a solution of the base. The salts may be precipitated from solution and collected by filtration, or may be recovered by other means such as by evaporation of the solvent.

In some embodiments, the seed treatment active may comprise one or more plant growth regulators including, but not limited to, ethephon and/or thidiazuron.

In some embodiments, the seed treatment active may comprise one or more karrakins, including but not limited to 2H-furo[2,3-c]pyran-2-ones, as well as analogues, derivatives, hydrates, isomers, polymers, salts and solvates thereof. Examples of biologically acceptable salts of karrakins include acid addition salts formed with biologically acceptable acids, examples of which include hydrochloride, hydrobromide, sulphate or bisulphate, phosphate or hydrogen phosphate, acetate, benzoate, succinate, fumarate, maleate, lactate, citrate, tartrate, gluconate; methanesulphonate, benzene sulphonate and p-toluenesulphonic acid. Additional biologically acceptable metal salts may include alkali metal salts, with bases, examples of which include the sodium and potassium salts. Karrakins may be incorporated into compositions in any suitable amount(s) or concentration(s). For example, the amount/concentration of a karrakin may be an amount or concentration effective to impart or confer a positive trait or benefit to a plant, such as to enhance the disease resistance, growth and/or yield of the plant to which the composition is applied. In an aspect, a karrakin amount/concentration may not be effective to enhance the disease resistance, growth and/or yield of the plant without beneficial contributions from one or more other ingredients of the composition, such as a LCO, CO and/or one or more pesticides.

In some embodiments, the seed treatment active may comprise one or more anthocyanidins and/or anthoxanthins, such as one or more of cyanidin, delphinidin, malvidin, pelargonidin, peonidin, petunidin, flavones (e.g., apigenin, baicalcin, chrysin, 7,8-dihydroxyflavone, diosmin, flavoxate, 6-hydroxyflavone, luteolin, scutellarein, tangeritin and/or wogonin) and/or flavonols (e.g., amurensin, astragalin, azaleatin, azalein, fisetin, furanoflavonols galangin, gossypetin, 3-hydroxyflavone, hyperoside, icariin, isoquercetin, kaempferide, kaempferitrin, kaempferol, isorhamnetin, morin, myricetin, myricitrin, natsudaidain, pachypodol, pyranoflavonols quercetin, quericitin, rhamnazin, rhamnetin, robinin, rutin, spiracoside, troxerutin and/or zanthorhamnin), and combinations thereof.

In some embodiments, the seed treatment active may include one or more gluconolactone and/or an analogue, derivative, hydrate, isomer, polymer, salt and/or solvate thereof. Gluconolactone may be incorporated into compositions in any suitable amount(s)/concentration(s). For example, the amount/concentration of a gluconolactone amount/concentration may be an amount effective to impart or confer a positive trait or benefit to a plant, such as to enhance the disease resistance, growth and/or yield of the plant to which the composition is applied. In an aspect, the gluconolactone amount/concentration may not be effective to enhance the disease resistance, growth and/or yield of the plant without beneficial contributions from one or more other ingredients of the composition, such as a LCO, CO and/or one or more pesticides.

In some embodiments, the seed treatment active may include one or more nutrient(s) and/or fertilizer(s), such as organic acids (e.g., acetic acid, citric acid, lactic acid, malic acid, taurine, etc.), macrominerals (e.g., phosphorous, calcium, magnesium, potassium, sodium, iron, etc.), trace minerals (e.g., boron, cobalt, chloride, chromium, copper, fluoride, iodine, iron, manganese, molybdenum, selenium, zinc, etc.), vitamins, (e.g., vitamin A, vitamin B complex (i.e., vitamin Bi, vitamin B2, vitamin B3, vitamin B5, vitamin Br,. Vitamin B7, vitamin Bx. Vitamin B9, vitamin Bn, choline) vitamin C, vitamin D, vitamin E, vitamin K.), and/or carotenoids (α-carotene, β-carotene, carotene, cryptoxanthin, lutein, lycopene, zeaxanthin, etc.), and combinations thereof. In an aspect, compositions of the present disclosure may comprise macro-and micronutrients of plants or microbes, including phosphorous, boron, chlorine, copper, iron, manganese, molybdenum and/or zinc. According to some embodiments, compositions may comprise one or more beneficial micronutrients. Non-limiting examples of micronutrients for use in compositions described herein may include vitamins, (e.g., vitamin A, vitamin B complex (i.e., vitamin B1, vitamin B2, vitamin B3, vitamin B5, vitamin B6, vitamin B7, vitamin B8, vitamin B9, vitamin B 12, choline) vitamin C, vitamin D, vitamin E, vitamin K, carotenoids (a-carotene, β-carotene, cryptoxanthin, lutein, lycopene, zeaxanthin, etc.), macrominerals (e.g., phosphorous, calcium, magnesium, potassium, sodium, iron, etc.), trace minerals (e.g., boron, cobalt, chloride, chromium, copper, fluoride, iodine, iron, manganese, molybdenum, selenium, zinc, etc.), organic acids (e.g., acetic acid, citric acid, lactic acid, malic acid, taurine, etc.), and combinations thereof. In a particular aspect, compositions may comprise phosphorous, boron, chlorine, copper, iron, manganese, molybdenum, and/or zinc, and combinations thereof. For compositions comprising phosphorous, it is envisioned that any suitable source of phosphorous may be used. For example, phosphorus may be derived from a rock phosphate source, such as monoammonium phosphate, diammonium phosphate, monocalcium phosphate, super phosphate, triple super phosphate, and/or ammonium polyphosphate, an organic phosphorous source, or a phosphorous source capable of solubilization by one or more microorganisms (e.g., Penicillium bilaiae).

In view of the above, the cleaning devices, systems and methods herein provide for an automated cleaning process of a mixing chamber in a seed treatment device (or a seed treater), through the use of various components such as pumps, vacuum sources, sprayers, recovery wands, etc. As such, cleaning of the seed treatment device may occur during off-hours of a site (e.g., during the night, at breaks, etc.), thereby eliminating the need of a user (in Tyvek suit) to clean the device and improving efficiency as a user is not required to be present. Additionally, the cleaning process sufficiently removes seed and seed treatment formulation residue build-up in the mixing chamber over a short time period while using small amounts water. For example, testing has shown that seed and seed treatment formulation residue build-up (e.g., wet film build-up, dry film build-up, etc.) may be sufficiently removed from a mixing chamber by spraying about 8 gallons of water into the mixing chamber over about 7 minutes.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above-mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A cleaning system for use with a seed treater, wherein the seed treater is configured to mix seeds and a seed treatment, the cleaning system comprising:
a fluid delivery assembly configured to couple to the seed treater, the fluid delivery assembly including a cover plate, and a sprayer and a recovery wand coupled to the cover plate; and
a fluid supply assembly configured to couple to the fluid delivery assembly, the fluid supply assembly including:
a pump configured to pump cleaning fluid to the sprayer for use in cleaning a mixing chamber of the seed treater of residual seed treatment and/or seeds; and
a vacuum source configured to create a vacuum at the recovery wand for use in retrieving the cleaning fluid from out of the mixing chamber of the seed treater.

2. The cleaning system of claim 1, wherein the fluid supply assembly further includes a tank configured to hold the cleaning fluid; and
wherein the pump is configured to pump the cleaning fluid from the tank to the sprayer for use in cleaning the mixing chamber of the seed treater of residual seed treatment and/or seeds, and wherein the recovery wand is configured to provide the cleaning fluid retrieved from the mixing chamber of the seed treater back to the tank.

3. The cleaning system of claim 1, wherein the cover plate is configured to detachably couple to a lid of the seed treater, to thereby position the sprayer and the recovery wand within the mixing chamber of the seed treater.

4. The cleaning system of claim 1, wherein the sprayer and/or the recovery wand are moveable relative to the cover plate, whereby the sprayer and/or the recovery wand are extendable into and out of the mixing chamber of the seed treater when the cover plate is coupled to the seed treater.

5. The cleaning system of claim 1, wherein the sprayer includes a spray arm and at least one spray nozzle attached to the spray arm.

6. The cleaning system of claim 5, wherein the spray arm is configured to rotate relative to the cover plate.

7. The cleaning system of claim 2, wherein the fluid supply assembly further includes one or more filters in fluid communication with the tank, and wherein the one or more filters are configured to remove at least a portion of the residual seed treatment and/or seeds from the retrieved cleaning fluid.

8. The cleaning system of claim 1, further comprising: a controller; and
an imaging module in communication with the controller, the imaging module configured to capture images of an interior portion of the mixing chamber.

9. A cleaning system for use with a seed treater, wherein the seed treater is configured to mix seeds and a seed treatment, the cleaning system comprising:
a fluid delivery assembly configured to couple to the seed treater, the fluid delivery assembly including a cover plate and a sprayer, the sprayer having a spray arm extending through the cover plate and at least one spray nozzle attached to the spray arm, the spray arm configured to move a defined distance relative to the cover plate; and
a fluid supply assembly configured to releasably couple to the fluid delivery assembly, the fluid supply assembly including:
a tank configured to hold cleaning fluid; and
a pump in fluid communication with the tank, the pump configured to pump the cleaning fluid from the tank to the at least one spray nozzle of the sprayer for use in cleaning a mixing chamber of the seed treater of residual seed treatment and/or seeds.

10. The cleaning system of claim 9, wherein the fluid delivery assembly further includes a recovery wand extending through the cover plate;
wherein the fluid supply assembly further includes a vacuum source configured to create a vacuum at the recovery wand for use in retrieving the cleaning fluid from the seed treater; and
wherein the recovery wand is configured to provide the retrieved cleaning fluid to the tank.

11. The cleaning system of claim 10, further comprising a controller configured to control the pump and the vacuum source.

12. The cleaning system of claim 9, wherein the tank includes a first reservoir, a second reservoir separated from the first reservoir, and a filter positioned in the first reservoir;
and wherein the filter is configured to remove at least a portion of the residual seed treatment and/or seeds from the retrieved cleaning fluid and funnel the portion of the residual seed treatment and/or seeds into the second reservoir while allowing the retrieved cleaning fluid to pass into the first reservoir.

13. The cleaning system of claim 9, further comprising an imaging module configured to capture images of an interior portion of the mixing chamber.

14. A seed treatment system comprising:
a seed treater including:
a mixing chamber in which seeds and a seed treatment are mixed when received therein;
a body including an inner surface defining at least part of the mixing chamber;
a rotor positioned at least partly in the body and including an inner surface defining at least a lower portion of the mixing chamber; and
a lid detachably coupled to the body; and
the cleaning system of claim 9.

15. A method of cleaning a mixing chamber of a seed treater, wherein the seed treater is configured to mix seeds and a seed treatment in the mixing chamber, the method comprising:
pumping cleaning fluid from a tank to a sprayer located in the mixing chamber of the seed treater;
discharging the cleaning fluid from the sprayer into the mixing chamber of the seed treater for cleaning the mixing chamber of residual seed treatment and/or seeds;
retrieving, via a recovery wand located in the mixing chamber of the seed treater, the cleaning fluid from the mixing chamber; and
transporting the retrieved cleaning fluid from the recovery wand to the tank.

16. The method of claim 15, wherein the sprayer includes a spray arm and at least one spray nozzle attached to the spray arm, the method further comprising moving the spray arm within the mixing chamber in a linear direction.

17. The method of claim 15, wherein pumping cleaning fluid includes recirculating the retrieved cleaning fluid from the tank to the sprayer after filtering the retrieved cleaning fluid.

18. The method of claim 15, further comprising capturing one or more images of an interior portion of the mixing chamber.

19. The method of claim 18, wherein pumping the cleaning fluid from the tank to the sprayer located in the mixing chamber of the seed treater includes automatically pumping the cleaning fluid from the tank to the sprayer located in the mixing chamber of the seed treater includes in response to the captured one or more images indicating presence of residual seed treatment and/or residual seeds in the interior portion of the mixing chamber.

20. The method of claim 18, further comprising activating at least one warning in response to the captured one or more images indicating presence of residual seed treatment and/or residual seeds in the interior portion of the mixing chamber.
